(19) United States
(12) Patent Application Publication
(10) Pub. No.: US 2025/0341827 A1
(43) Pub. Date: Nov. 6, 2025

(54) INTELLIGENT WORKFLOW PROMPTING

(71) Applicant: INTERNATIONAL BUSINESS MACHINES CORPORATION, Armonk, NY (US)

(72) Inventors: Jennifer M. HATFIELD, Portland, OR (US); Sarbajit Kumar RAKSHIT, Kolkata (IN); Carolina Garcia DELGADO, Zapopan (MX); Michael BOONE, Lutz, FL (US)

(21) Appl. No.: 18/651,915

(22) Filed: May 1, 2024

(51) Int. Cl. G05B 23/02; G06Q 10/0631; G06T 19/00

(52) U.S. Cl. CPC G05B 23/027; G05B 23/024; G06Q 10/06311; G06T 19/003; G06T 2219/024

(57) ABSTRACT

Methods, computer program products, and systems are presented. The method computer program products, and systems can include, for instance: storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment.

### BACKGROUND

Embodiments herein relate generally to workflows and specifically to intelligent workflows.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) denotes the capability of machines to demonstrate intelligence. AI research encompasses endeavors such as search algorithms, mathematical optimization, neural networks, and probability analysis. AI solutions integrate insights from diverse scientific and technological domains including computer science, mathematics, psychology, linguistics, statistics, and neuroscience. Machine learning, commonly defined as the study enabling computers to learn without explicit programming, is regarded to be a significant aspect of AI.

A digital twin serves as a virtual rendition of a physical entity, be it an object, system, or any other asset. It mirrors alterations occurring throughout the lifespan of the physical counterpart, documenting these changes in real-time. These twins manifest as intricate virtual models, mirroring their physical counterparts precisely. By linking sensors and Internet-of-Things (IoT) devices to the physical asset, data is continuously gathered, often in real-time, and mapped onto the digital twin. This enables individuals, such as engineers, to remotely access real-time information regarding the physical asset's operations without physically being present. Through the digital twin, users gain insights not only into the current performance of the physical asset but also into its future behavior, leveraging data collected from sensors, IoT devices, and other sources. Additionally, digital twins provide manufacturers and asset providers with invaluable insights into post-purchase consumer behavior, aiding in the understanding of product usage patterns beyond the point of sale.

### SUMMARY

Shortcomings of the prior art are overcome, and additional advantages are provided, through the provision, in one aspect, of a method. The method can include, for example: storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment.

In another aspect, a computer program product can be provided. The computer program product can include a computer readable storage medium readable by one or more processing circuit and storing instructions for execution by one or more processor for performing a method. The method can include, for example: storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment.

In a further aspect, a system can be provided. The system can include, for example, a memory. In addition, the system can include one or more processors in communication with the memory. Further, the system can include program instructions executable by the one or more processors via the memory to perform a method. The method can include, for example: storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system workflow environment enterprise systems and user equipment UE devices according to one embodiment;

FIG. 2 depicts a workflow environment according to one embodiment;

FIG. 3A-3B is a flowchart depicting a method for performance by a manager system interoperating with enterprise systems, IoT devices, and UE devices according to one embodiment;

FIG. 4 depicts a workflow guiding predictive model according to one embodiment;

FIG. 5 depicts clustering analysis according to one embodiment;

FIG. 6 depicts a worker action impact predictive model according to one embodiment;

FIG. 7 depicts the skeletal representation of workers according to one embodiment;

FIG. 8 depicts a worker movement predictive model according to one embodiment;

FIG. 9 depicts a pattern recognition predictive model according to one embodiment;

FIG. 10 depicts a neural network according to one embodiment.

FIG. 11 depicts a computing environment according to one embodiment.

### DETAILED DESCRIPTION

In one aspect, embodiments herein can optionally include storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes evaluating accuracy of one or more key performance indicator (KPI) prediction resulting from the performing the simulation, wherein the detecting that the alert condition is present is in dependence on the evaluating. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes evaluating accuracy of one or more key performance indicator (KPI) prediction resulting from the performing the simulation, wherein the detecting that the alert condition is present is in dependence on evaluating, wherein the prompting the one or more worker to take action in response to the detecting that the alert condition is present in the workflow environment includes prompting the one or more worker to take action via UE devices of the one or more worker. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the detecting, in dependence on the performing the simulation that an alert condition is present in the workflow environment includes determining that the alert condition is characterized by one or more predicted KPI parameter value predicted by the simulation failing to satisfy a performance threshold, and ascertaining that the alert condition is characterized by a predictive accuracy of the simulation failing to satisfy an accuracy threshold, wherein the prompting one or more worker within the workflow environment to take action in response to the detecting that the alert condition is present in the workflow environment includes generating first prompting data in dependence on the determining, and producing second prompting data in dependence on the ascertaining. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes subsequent to the prompting one or more worker within the workflow environment to take action, recording data specifying responsive action performed by the one or more worker responsively to the prompting, applying the data specifying the responsive action as training data for training a machine learning predictive model, querying the machine learning predictive model subsequent to the training, and generating subsequent prompting data for prompting at least one worker within the workflow environment in dependence on the querying. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes evaluating accuracy of one or more key performance indicator (KPI) prediction resulting from the performing the simulation, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the performing the simulation includes querying a predictive machine learning model that has been trained with training data that includes the historical IoT data of the IoT sensor data, wherein the method includes evaluating accuracy of one or more key performance indicator (KPI) prediction resulting from the performing the simulation, wherein the evaluating the accuracy of the one or more key performance indicator (KPI) prediction resulting from the performing the simulation includes comparing real time KPI data to predicted KPI data produced on querying the predictive machine learning model with use of a test query, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes recording data specifying an historical action of at least one worker within the workflow environment, storing historical impact data indicating an impact of the historical action on at least one key performance indicator (KPI) of the workflow environment, and predicting with use of the historical impact data a result of performing a candidate action, wherein the prompting one or more worker within the workflow environment to take action in response to the detecting that the alert condition is present in the workflow environment includes prompting the one or more worker within the workflow environment to take action in dependence on the predicting. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions, wherein the predicting includes querying a trained machine learning model that has been trained with training data provided by the impact data of the historical impact data. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the performing the simulation includes querying a predictive neural network machine learning model that has been trained with training data that includes the historical IoT data of the IoT sensor data, wherein the method includes evaluating accuracy of one or more key performance indicator (KPI) prediction resulting from the performing the simulation, wherein the evaluating the accuracy of the one or more key performance indicator (KPI) prediction resulting from the performing the simulation includes comparing real time KPI data to predicted KPI data produced on querying the predictive neural network machine learning model with use of a test query, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually, wherein the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions, wherein the predicting includes querying a trained machine learning model that has been trained with training data provided by the impact data of the historical impact data. According to an example of a technical effect of the combination, interactive presentment of prompting data according to the combination can enhance user interface engagement of one or more worker with a workflow environment to facilitate improved operating performance of one or more physical asset within the workflow environment.

According to one optional feature, the method includes recording data specifying historical actions of one or more group of workers within the workflow environment, wherein the recording includes obtaining an image presentation of two or more workers, processing an image representation to produce a skeletal multi-joint representation of the two or more workers, and querying a trained neural network with use of the skeletal multi-joint representation of the two or more workers for return of an action classifier for the two or more workers, storing, for respective ones of the historical actions of the one or more group of workers impact data indicating an impact of the respective ones of the historical actions on at least one key performance indicator (KPI) of the workflow environment, and predicting, with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions. According to an example of a technical effect of the combination, interactive presentment of prompting data according to the combination can enhance user interface engagement of one or more worker with a workflow environment to facilitate improved operating performance of one or more physical asset within the workflow environment.

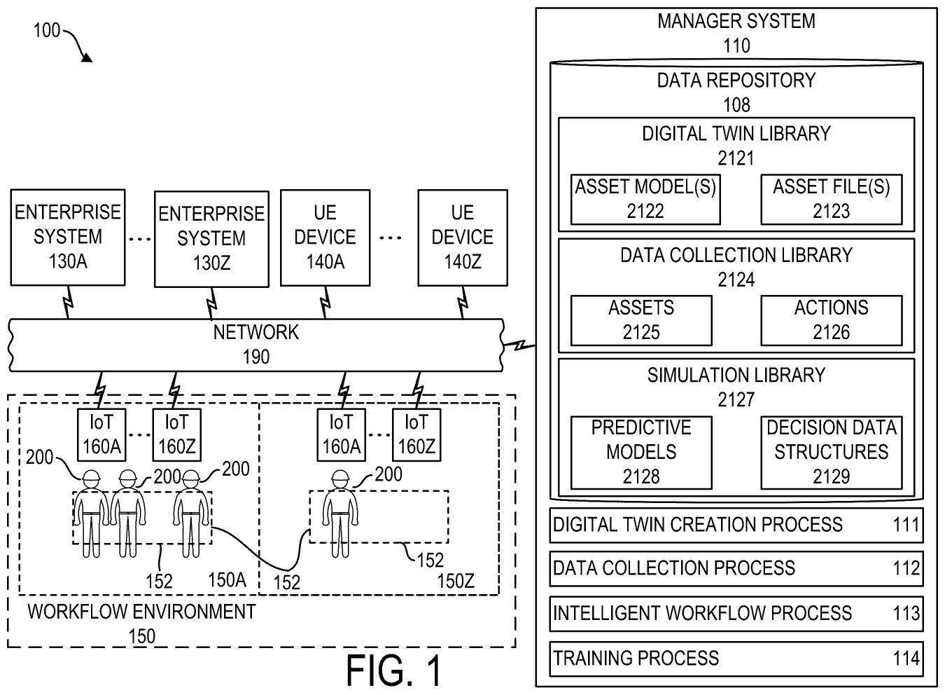

System 100 for use in implementing and enforcing an artificial intelligence (AI) enabled intelligent workflow is shown in FIG. 1. System 100 can include manager system 110 having data repository 108, workflow environment 150, and user equipment UE devices 140A-140Z. In workflow locations 150A-150Z of workflow environment 150, there can be disposed respective sets of Internet of Things (IoT) devices 160A-160Z. Each workflow location can include one or more IoT device and in some respective workflow locations can include IoT devices 160A-160Z. Manager system 110, IoT devices 160A-160Z of workflow locations 150A-150Z of workflow environment 150 and UE devices 140A-140Z can be in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. In the context of workflow locations 150A-150Z, IoT devices 160A-160Z, and UE devices 140-140Z, “Z” can refer to any positive integer. In some use cases, IoT devices can be collocated with UE devices 140A-140Z.

Within each workflow location of workflow environment 150, there can be disposed one or more physical asset 152, e.g., a machine such as an industrial machine. UE devices of UE devices 140A-140Z can include, e.g., UE devices for input of controls into workflow environment 150A. Such UE devices can include, e.g., laptops, smart phones, tablets, personal computers, PCs, custom control panels, and the like. UE devices of UE devices 140A-140Z can also include virtual reality (VR) headsets for implementation of virtual reality sessions. Manager system 110 can run various processes.

Manager system 110 can run digital twin creation process 111, data collection process 112, intelligent workflow process 113, and training process 114. Intelligent workflows herein can include workflows involving and in dependence on actions of human users such as workers 200 shown distributed within workflow environment 150. Embodiments herein can include features so that workflow workers 200 can be prompted to take action within workflow environment 150. Embodiments herein can include features so that data specifying actions of workers 200 during a deployment period of workflow environment can be recorded within data repository 108.

Embodiments herein can include features so that historical data stored in data repository 108 can be processed for generation of prompts delivered to workers 200 prompting workers 200 to take action within workflow environment 150. Manager system 110 running intelligent workflow process 113 can include manager system 110 querying one or more predictive model that has been trained to perform a simulation that simulates performance of a physical asset, e.g., an industrial machine.

Manager system 110 running training process 114 can include manager system 110 training by machine learning one or more predictive model. In the course of deployment of system 100, manager system 110 can be iteratively training a plurality of predictive models for performance of simulations that simulate operations of one or more physical asset. Manager system 110 performing training process 114 can include manager system 110 applying as training data that has been stored within digital twin library 2121 and/or data collection library 2124 of data repository 108.

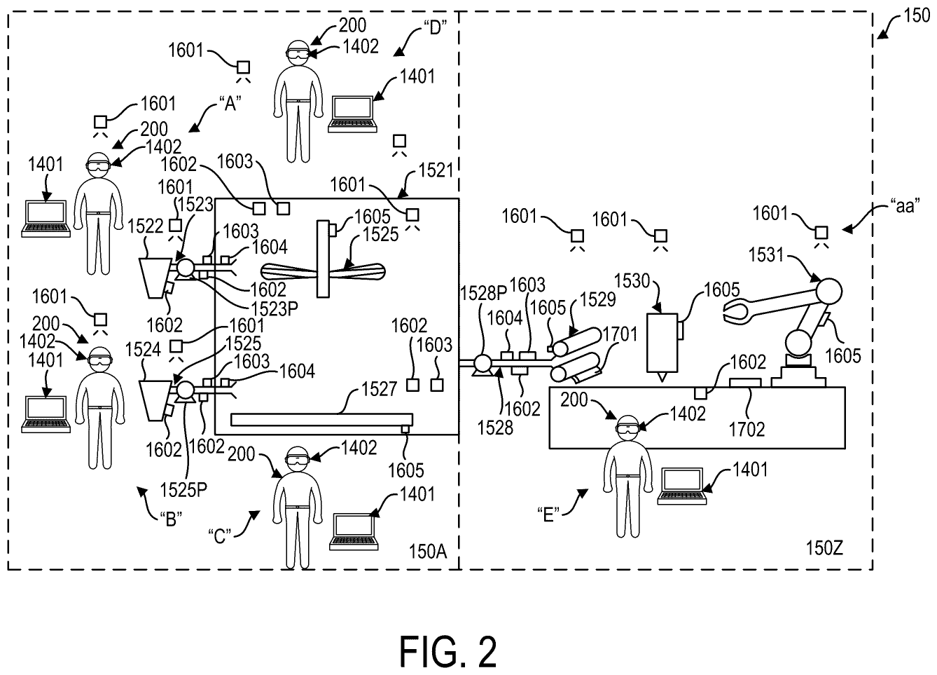

FIG. 2 depicts a specific example of workflow environment 150. Workflow environment 150 of FIG. 2 includes first workflow location 150A and second workflow location 150Z, wherein the first workflow location 150A maps to and specifies a first stage of an industrial process such as an assembly line industrial process and second workflow location 150Z maps to and specifies a second stage of the industrial process. Within each location depicted there can be different regions defined by different geographical coordinate locations of workflow environment 150. Workflow location 150A can include a first region at A, a second region at B, a third region at C, and a fourth region at E. Second workflow location 150Z can include a first region at E. In the depicted embodiment of FIG. 2, each of the regions A, B, C, D, and E can include a different worker 200 defining an assigned worker for the region and having a role associated to one or more physical asset 152 of the region. Worker 200 at region A herein can be referred to as worker A, worker 200 at region B herein can be referred to as worker B, worker 200 at region C herein can be referred to as worker C, worker 200 at region D herein can be referred to as worker D, worker 200 at region E herein can be referred to as worker E.

In some embodiments, virtual reality (VR) may be provided to users and integrated into manager system 110. For example, worker users may use VR devices such as a VR headset to view one or more digital twin model 2122 virtually rendered in VR space. Worker users may interact with the one or more asset model being rendered on a VR device by touching or selecting one or more components that are rendered, as a method for establishing settings of a simulation. Worker users may view and interact with multiple renderings of asset models using respective VR devices. In one embodiment, VR herein can include augment reality (AR) functionality wherein virtual representations can be rendered to a user while a worker user is interacting with a live environment. In one embodiment VR herein can be absent of AR functionality.

Each depicted worker 200 can operate a plurality of UE devices such as laptop 1401 for input of controls for controlling one or more physical asset of workflow environment 150A and VR headset 1402 for viewing asset model renderings and for implementation of controls, e.g., via eye movement of one or more physical asset of workflow environment 150.

Laptop 1401 and VR headset 1402 can also be configured to display feedback data including prompting data to the respective workers 200 at the various respective regions A through E. At workflow location 150A, there can be disposed machine 1521 such as a materials processing machine that mixes materials.

At location 150A, there can be disposed a feedstock loader 1523 for loading a first material into processing machine 1521 and a second feedstock loader 1524 for loading a second material into material processing machine 1521. Feedstock loader 1523 can be located within region A and feedstock loader 1524 can be located within region B. The worker in region A can be charged with operating feedstock loader 1523, while the worker at region B can be charged with operating feedstock loader 1524.

Processing machine 1521 can further include heater 1527 for heating materials in agitator 1525 for agitating materials loaded into machine 1521. Worker 200 at region C can be charged with operating heater 1527 while worker 200 at region D can be charged with operating agitator 1526. Location 150Z can include location 150Z of workflow environment 150 as shown in FIG. 2 can include, e.g., a roller 1527 for rolling the mixed output produced by machine 1521 for production of product 1701 that is cut by cutter and robot 1529 for placement of cut and finished products into product container 1702.

Worker 200 at region E can be charged with operation of roller 1527, cutter 1528, and robot 1529. Various IoT devices defining IoT devices 160A-160Z shown in FIG. 1 can be distributed throughout workflow environment 150A. Workflow environment 150 can include, e.g., camera image sensor IoT devices 1601 for recording camera images. Camera image sensor IoT devices 1601 can be disposed within each region of regions A to E for recording images of physical assets as well as actions of workers 200.

Workflow environment 150 can also include various temperature sensor IoT devices 1602, e.g., disposed on feedstock loader 1522, on feedstock loader 1524, at fluid channel 1523 between feedstock loader 1522 and processing machine 1521, at fluid channel 1703 between feedstock loader 1524 and processing machine 1521, within processing machine 1521 at various locations, at the fluid channel 1528 between machine 1521 and roller 1527 at the platform of robot 1529.

Workflow environment 150 can further include distributed therein pressure sensors 1603, e.g., disposed within processing machine 1521. Workflow environment 150A can also include distributed therein pressure sensors 1603. Pressure sensors 1603 can be disposed, e.g., at the fluid channel 1523 between feedstock loader 1522 and machine 1521, at fluid channel 1525 between feedstock loader 1524 and machine 1521, at fluid channel 1724 between machine 1521 and roller 1527.

Workflow environment 150 can include a flow rate sensor IoT devices 1604 at the fluid channel 1523 between feedstock loader 1522 and machine 1521, at fluid channel 1525 between feedstock loader 1524 and machine 1521 and can also include flow sensor IoT device 1604 at the fluid channel 1528 between machine 1521 and roller 1527.

Workflow environment 150 can also include various valves 1705. FIG. 2 depicts one example of an assembly line industrial process defined by workflow environment 150. Workflow environment 150 can include another type of assembly line process, such as an assembly line process for assembly of, e.g., appliances, electronics goods, furniture, or vehicles were the various workflow locations 150A and 150Z correspond to vehicle assembly stages, e.g., stamping and welding, welding and painting, painting and engine, engine and trim, and the like.

Data repository 108 can include digital twin library 2121 which can store one or more digital twin asset model 2122 and one or more digital twin file 2123. The one or more digital twin asset model 2122 can include parameter data that specifies physical characteristics of one or more physical asset 152 of workflow environment 150.

In one example, model data defining one or more digital twin asset model 2122 can include a 3D model or computer aided design (CAD) drawing. One or more digital twin asset model 2122 can be tracked over multiple points in time and states of the one or more physical asset 152. For example, an iteration of the digital twin can be stored as a 3D model or CAD drawing at the original point of creation of the digital twin depicting the originally received one or more physical asset 152 (the “base asset”). A new iteration of the one or more digital twin asset model 2122 may be created and stored every time the one or more physical asset 152 is modified and such change is permeated to the associated digital twin. A user accessing the one or more digital twin asset model 2122 may be able to view an entire timeline of models or drawings depicting the digital twin as the digital twin matures over time, creating a series of one or more digital twin asset model 2122 representing the evolution of the digital twin (and one or more physical asset 152) at various timepoints over the lifetime of the one or more physical asset 152.

In one example, one or more digital twin asset model 2122 can be continuously updated to accurately depict one or more physical asset 152 shown in FIG. 1. The one or more digital twin asset model 2122 may be displayed on a human-readable interface, such as a display of a UE device of UE devices 140A-140E and provide one or more details describing the one or more digital twin asset model 2122 or the one or more physical asset 152 being depicted, including make, model, purchase date, amount of time the physical asset has been used, etc. Embodiments of the one or more digital twin asset model 2122 can change to reflect the status of the physical asset (in real-time, or near real-time in some embodiments). FIG. 2 can represent one or more physical asset 152 (FIG. 1) which has received one or more replacement part or maintenance that differ from a base one or more physical asset 152. In one example, an iteration of one or more digital twin asset model 2122 reflecting the replacement of a replacement part and may include additional details logging the replacement part installed, the name of the replacement part installed, the time the replacement occurred or additional details describing the replacement process. As noted above, digital twin library 2121 may store multiple versions of the one or more digital twin asset model 2122 as the digital twin changes over time.

In one example, a one or more digital twin asset model 2122 can represent a physical asset defining an entire assembly line, e.g., the entirety of physical assets 1521-1531 defining an assembly line as shown in the workflow environment of FIG. 2. In one example, a one or more digital twin asset model 2122 can represent a physical asset defining a portion of an assembly line, e.g., a subset of physical assets 1501-1531 as shown in the workflow environment of FIG. 2.

Embodiments of the digital twin library 2121 can store one or more digital twin asset file 2123 as shown in FIG. 1. The one or more digital twin asset file 2123 can include a digitized contract or agreement, agreed upon between the buyer (or licensee) of the one or more physical asset 152 and the manufacturer, seller or licensor providing the one or more physical asset 152. Embodiments of such an agreement can specify terms of the contract and conditions upon which the contract will be considered satisfied for the purposes of initiating the creation of the digital twin and permitting access to the one or more digital twin asset model 2122. For example, embodiments of an agreement defining a digital twin asset file can specify terms of the contract, such as the length of time the digital twin and the associated one or more digital twin asset model 2122 and/or one or more digital twin asset file 2123 will remain accessible (i.e., 5, 10, 20, 30 years, etc.), and terms describing ownership change and procedures defined by the digital twin asset agreement. Moreover, the terms of a digital agreement twin asset agreement can include conditions describing the initial files that can be required to be deposited into digital twin library 2121 by the manufacturer, seller or licensee, in order to satisfy the digital twin requirements of the digital twin asset agreement. The initial files (along with any additional files and/or updates to the initial files) can be stored as one or more digital twin asset file 2123. Examples of digital twin asset files that can be deposited in the digital twin library 2121 can include (but are not limited to) user manuals, operation manuals, bill of materials, warranties, maintenance plans or maintenance schedules, specifications of the one or more physical asset 152, specifications of IoT devices 160A-160Z, logs of one or more physical asset 152 performance, logs of physical asset device readings, fault codes, ownership history, and documents effectuating a change in ownership of the one or more physical asset 152, virtual reality instructions, artificial intelligence or machine learning models and media resources. In some embodiments, an agreement defining one or more digital twin asset file 2123 can specify the standards and/or formats of remaining files defining one or more digital twin asset file 2123 being deposited in digital twin library 2121 of data repository 108.

In data collection library 2124, data repository 108 can store collected history data of workflow environment 150. Collected data can include data of one or more physical asset 152 in assets area 2125 and data of one or more action of a human worker 200 in actions area 2126. The described data of assets area 2125 and action area 2126 can include data received from IoT devices 160A-160Z of one or more workflow environment location 150A-150Z.

Embodiments of the data collected by manager system 110 into data collection library 2124 may be captured as a real-time data feed streamed by IoT devices 160A-160Z of one or more workflow environment location 150A-150Z.

During operation of the one or more physical asset 152 (FIG. 1), IoT devices 160A-160Z of one or more workflow environment location 150A-150Z can generate data describing the operation, functionality, and performance of the one or more physical asset 152. The collected datasets of asset area 2125 that are generated by IoT devices 160A-160Z of one or more workflow environment location 150A-150Z can describe the overall health and performance of the one or more physical asset 152 in its current state, help diagnose potential maintenance needs, repairs, or failing parts that may need replacement. For example, IoT devices 160A-160Z of one or more workflow environment location 150A-150Z may identify and record changes in temperatures within the one or more physical asset 152 over a period of time, identify a presence of an abnormal heat buildup and help diagnose the source of the heat. For instance, an IoT device may show the temperature at various locations within the one or more physical asset 152 including locations of the one or more physical asset 152 that have the highest temperature levels. These heightened temperature levels may be elevated near malfunctioning parts that may be exhibiting abnormal levels of friction. Thermal images stored in assets area 2125 may confirm the buildup of heat at a particular location and visually depict the changes in the thermal images being collected over time. Additional IoT devices may pinpoint parts and components that may be misaligned, experiencing excess vibration or noise, improperly functioning, broken down, or improperly wearing against one another, causing the abnormal levels of friction and report the abnormal functions as evidenced by the misalignment, excess vibration, noise, friction, or other evidence of improper functionality.

Embodiments of IoT devices 160A-160Z operationally integrated into the one or more physical asset 152 can also provide errors or diagnostic codes, which may further assist with identifying potential issues, that may alert the user or owner of pending problems with one or more physical asset 152 which may impact the performance of the one or more physical asset 152 and the state of operational materials. Through the use of the collected datasets of assets area 2125 organized, analyzed, and/or formatted by manager system 110, manager system 110 may analyze the performance of one or more physical asset 152 modelled by one or more digital twin asset model 2122, identify failing parts, provide resolutions to cure errors or diagnostic codes and recommend optimal actions to improve or optimize the performance of the one or more physical asset 152, including the replacement of operational materials alongside failing parts and/or regular maintenance schedules which can include regular changes to operational materials, e.g., fluids installed within the one or more physical asset 152.

Embodiments of the digital twin creation process 111 may perform tasks or functions associated with creating a new one or more digital twin asset model 2122 reflecting a current state of a one or more physical asset 152. Each of the one or more digital twin asset model 2122 may be stored as part of a digital twin library 2121. In some embodiments, initial versions of the one or more digital twin asset model 2122 depicting the new one or more physical asset 152 provided by the manufacturer at the time of purchase may be referred to as the “base form” model. The digital twin of the new base form may be provided as a new version of one or more digital twin asset model 2122 within the digital twin library 2121.

In some embodiments, the digital twin creation process 111 may receive specifications of the one or more physical asset 152 from users, manufacturer, or third parties, in the form of one or more digital twin files describing the parts, components, and input materials, e.g. operating fluids, of the one or more physical asset 152. Embodiments of the digital twin creation process 111 may create a one or more digital twin asset model 2122 depicting the original base form of the one or more physical asset 152 from the supplied specifications of the one or more physical asset 152 (e.g. referred to as the “base asset”) and store the one or more digital twin asset model 2122 generated from one or more digital twin files and specifications of the physical asset to the digital twin library 2121.

Embodiments of the digital twin creation process 111 may further create additional one or more digital twin asset model 2122 representing different versions of the one or more physical asset 152 over time. As the one or more physical asset 152 changes over time, including changes to one or more components, configurations, hardware, software, firmware, maintenance, repairs, or as measured by IoT devices 160A-160Z of one or more workflow environment location 150A-150Z including measurements of heat output depicted in thermal images, the digital twin creation process 111 may create a new one or more digital twin asset model 2122 reflecting the current state and/or condition of the one or more physical asset 152 as a one or more digital twin asset model 2122. Embodiments of the digital twin creation process 111 may store the plurality of different one or more digital twin asset model 2122 in digital twin library 2121. Embodiments of the digital twin library 2121 may be maintained as part of data repository 108 and may comprise one or more digital twin asset model of one or more physical asset 152 of workflow environment 150.

In some embodiments, the multiple versions of the one or more digital twin asset model 2122 may be sequenced temporally or configured to fit along a time-based scale and/or timeline in order to track the evolution of the one or more physical asset 152 and the subsequent changes. These changes can include changes, replacements, and modifications to the parts, components, input materials, configurations, settings, operational output, and the surrounding environment. Each point in time is reflected by a new one or more digital twin asset model 2122 that may be created by the digital twin creation process 111 to catalog the state of the one or more physical asset 152 and the details of operating capabilities of the one or more physical asset 152 and performance as measured by IoT devices 160A-160Z of one or more workflow environment location 150A-150Z and represented in the one or more digital twin asset model 2122.

Changes to the one or more digital twin asset model 2122 that may result in the creation of a new version of a one or more digital twin asset model 2122 may be self-reported by users or owners of the one or more physical asset 152 in some instances. For example, a user may perform repairs, maintenance, reconfigure settings, replace input materials, and/or install or remove components of the one or more physical asset 152 and report the imposed changes to manager system using a UE device of UE devices 140A-140Z.

In response to the reported changes, the digital twin creation process 111 may create a new version of the one or more digital twin asset model 2122 to reflect the reported changes to the one or more physical asset 152, and store the new version of the one or more digital twin asset model 2122 within the digital twin library 2121.

In other instances, embodiments of the one or more digital twin asset model 2122 may be tracked based on changes to performance data, environmental data, and operational data collected by IoT devices 160A-160Z of one or more workflow environment location 150A-150Z monitoring the state of the one or more physical asset 152. Collected data describing the state and operational performance of one or more physical asset 152 may indicate the presence of changes to the one or more physical asset 152, including, e.g., changes to input materials, failing parts, or improper configurations giving rise to increased thermal output, heat, or other detrimental effects within the one or more physical asset 152.

Based on changes to the collected data being monitored, a new one or more digital twin asset model 2122 may be created to reflect a change in the state of the input materials, a presence of failing parts or components, and/or an increase or decrease in the amount of heat being generated and recorded by IoT devices 160A-160Z of one or more workflow location. For instance, manager system 110 can process data respecting the performance of one or more physical asset 152, component configurations (including makes and models of the component), timings or settings of components and parts, an increase or decrease of heat output, increased or decreased levels of friction between components which may be generating the heat (for example due to misalignment), abnormal behavior from parts (for example, increased levels of vibration). As the operating conditions of the one or more physical asset 152 change, in particular changes in heat output, increased levels of friction, abnormal output data, changes to parts or components, manager system 110 running digital twin creation process 111 can create a new one or more digital twin asset model 2122 accurately reflecting the changes in the state of the one or more physical asset 152.

In some embodiments, the presence of new components, configurations, or other changes to the one or more physical asset 152 may be deduced by the performance characteristics, parameters, and operational conditions expressed by the real-time data feed from IoT devices 160A-160Z of one or more workflow environment location 150A-150Z. Deviations between previously collected data and the most recent datasets extracted from the real-time data feed as determined by manager system 110 processing data from assets area 2125 of data collection library 2124 can result in the identification of changes to the one or more physical asset 152 and/or changes in the health of the one or more physical asset 152. For example, changes in performance may indicate the presence of new parts or components, failing or misaligned parts, repairs, modified configurations, software or firmware update, damage, failing operational materials, etc. Manager system 110 may analyze the performance changes based on the changes in the data collected from the real-time data feed and reflect the changes to the one or more physical asset 152 as a new one or more digital twin asset model 2122 in some embodiments. For instance, manager system 110 can add a new version of the one or more digital twin asset model 2122 to the digital twin library 2121, reflecting the updates, repairs, changes, or performance state of the one or more physical asset 152.

Digital twin library 2124 and digital twin creation process 111 can define a digital twin. A digital twin herein can refer to a virtual representation of a physical object, system or other asset. The digital twin tracks changes to the physical object, system or asset across the object's lifespan and records the changes as they occur. Digital twins can define a complex virtual model that is a precise counterpart to the physical asset existing in real space. Sensors and internet-of-things (IoT) devices connected to the physical asset collect data, often in real-time. The collected data can then be mapped to the virtual model of the digital twin. Any individual with access to the digital twin can see the real-time information about the physical asset operating in the real world without having to be physically present and viewing the physical asset while operating. Rather, users such as engineers can use the digital twin to understand not only how the physical asset is performing, but to predict how the physical asset may perform in the future. using the collected data from sensors, IoT devices and other sources of data and information being collected. Moreover, digital twins can help manufacturers and providers of physical assets with information that helps the manufacturer understand how customers continue to use the products after the purchasers have bought the physical asset.

Manager system 110 running data collection process 112 may perform the functions, tasks, or operations associated with collecting, extracting, organizing, maintaining, formatting, and/or storing data received from IoT devices 160A-160Z of one or more workflow environment location 150A-150Z defining a real-time data feed, including data describing the state of the one or more physical asset 152 such as the state of one or more parts and components, input materials, the surrounding environment and operational environment of the one or more physical asset 152.

Embodiments of the data collected by the data collection process 112 may be captured as a real-time data feed streamed by IoT devices 160A-160Z of one or more workflow environment location 150A-15Z providing the data to the data collection process 112.

During operation of the one or more physical asset 152, IoT devices 160A-160Z of one or more workflow environment location 150A-150Z can generate data describing the operation, functionality, and performance of the one or more physical asset 152. The collected datasets of assets area 2125 can describe the overall health and performance of the one or more physical asset 152 in its current state (including a state of operational materials), help diagnose potential maintenance needs, repairs, or failing parts that may need replacement. For example, IoT devices 160A-160Z of one or more workflow environment location 150A-150Z may identify and record changes in temperatures within the one or more physical asset 152 over a period of time, identify a presence of an abnormal heat buildup and help diagnose the source of the heat. For instance, IoT devices 160A-160Z of one or more workflow environment location 150A-150Z may show the temperature at various locations within the one or more physical asset 152 including locations of the one or more physical asset 152 that have the highest temperature levels. These heightened temperature levels may be elevated near malfunctioning parts that may be exhibiting abnormal levels of friction. Thermal images recorded within assets area 2125 may confirm the buildup of heat at a particular location and visually depict the changes in the thermal images being collected over time. Additional IoT devices 160A-160Z of one or more workflow environment location 150A-150Z may pinpoint parts and components that may be misaligned, experiencing excess vibration or noise, improperly functioning, broken down, or improperly wearing against one another, causing the abnormal levels of friction and report the abnormal functions as evidenced by the misalignment, excess vibration, noise, friction, or other evidence of improper functionality expressed by the digital twin to the data collection process 112. Manager system 110 can update data of digital twin library 2121 in dependence on collected data of data collection library 2124.

In another aspect, manager system 110 can run intelligent workflow process 113. Manager system 110 running intelligent workflow process 113 can include manager system 110 performing simulations of one or more physical asset 152 operations using one or more digital twin asset model 2122 to predict the performance of the one or more physical asset 152 in a future state, using a current state, a previous state, and/or in a hypothetical configuration of the physical asset, represented by one or more digital twin asset model 2122. Simulations performed by the intelligent workflow process 113 can include simulations using one or more input parameters corresponding to one or more selected one or more digital twin asset model 2122 of digital twin library 2121, as well as collected current and/or historical data stored in data collection library 2124. Embodiments of the intelligent workflow process 113 can perform digital twin simulations of the one or more physical asset 152 using one or more versions of the one or more digital twin asset model 2122 created and stored by the digital twin library 2121, as part of a timeline describing the evolution of the one or more physical asset 152 over time. For instance, a simulation may be performed using the most current one or more digital twin asset model 2122 and/or an historical model of one or more digital twin asset model 2122.

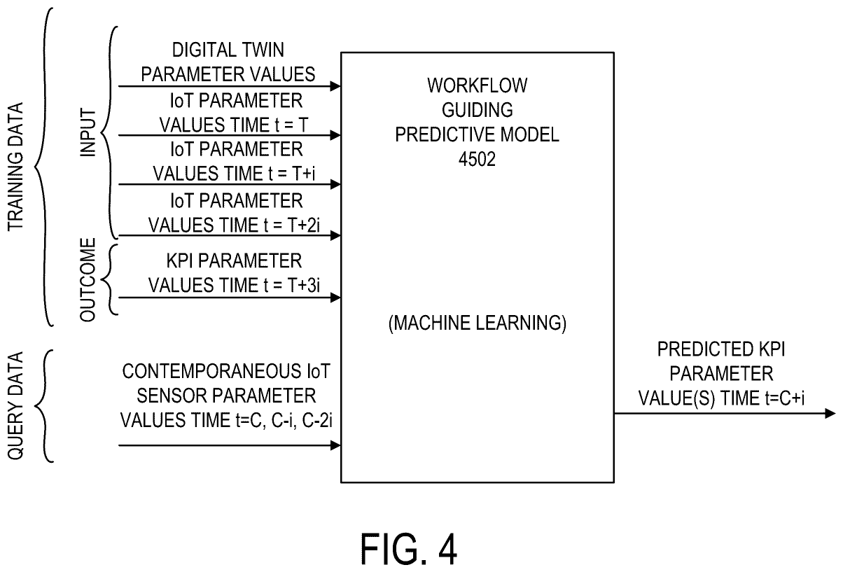

Manager system 110 running intelligent workflow process 113 can include manager system 110 simulating performance of one or more physical asset 152 with use of one or more predictive model stored in predictive models area 2128. Predictive models stored in predictive models area 2128 can drive simulations of one or more physical asset 152 defining workflow environment 150. Manager system 110 can train one or more predictive model such as workflow guiding predictive model 4502 as set forth in FIG. 4, with use of data from digital twin library 2121 and/or data collection library 2124. Once trained, manager system 110 can query workflow guiding predictive model 4502 for return of predictions defining simulated performance of one or more physical asset 152.

Workflow environment 150 can include temperature sensor IoT device 1602 at fluid channel 1523, temperature sensor IoT device 1602 at fluid channel 1525 and can include temperature sensor IoT device 1602 at fluid channel 1528.

In a further aspect of workflow environment 150 depicted in FIG. 2, camera image sensor IoT device 1601 defining IoT devices 160A-160Z can be provided by three-dimensional point cloud camera IoT devices that are enabled to capture 3D point cloud image data.

In another aspect of workflow environment 150, IoT devices 160A-160Z can be defined by reading sensor IoT devices 1605. Reading devices 1605 can be distributed within workflow environment 150 at electrical power consuming physical assets of workflow environment 150 for generating data specifying electrical power consumption of the various electrical power consuming physical assets.

As shown in FIG. 2, reading device sensor IoT devices 1605 can be distributed, e.g., on agitator 1526, heater 1527, roller 1529, cutter 1530, robot 1531, as well as on pumps 1523P, 1525P, and 1528P. Reading IoT sensor devices 1605 can incorporate therein settings readers and watt meters. In one aspect, the respective physical assets 1521 to 1531 of workflow environment 150 can include respective reading IoT sensor devices 1605. Reading IoT sensor devices 1605 can be configured to perform settings readings of the respective physical assets 1521 to 1531, as well as meter readings of the respective physical assets 1521 to 1531. Pump physical assets 1523P. 1525P, and 1528P can include, incorporated therein respective reading IoT sensor devices according to reading IoT sensor devices 1605.

Data repository 108 can further include simulation library 2127. Simulation library 2127 can include predictive models area 2128 and decision data structures area 2129. In predictive models area 2128, simulation library 2127 can store predictive models that are trained by machine learning with use of training data, e.g., training data provided by data from data collection library 2124. Predictive models of predictive models area 2128 can be trained using training data to provide simulations for performance of predictions on functions that are performed by one or more physical asset 152 of workflow environment 150.

In decision data structures area 2129, there can be stored one or more decision data structure for use in return of an action decision. Decision data structures stored in decision data structures area 2129 can include, e.g., decision tables and decision trees.

In actions area 2126, data collection library 2124 can store data specifying actions performed by workers 200 of workflow environment 150. Actions of workers 200 can include, e.g., control input actions of users specifying control inputs that have been manually input by worker users into a UE device of UE devices 140A-140Z for control of one or more physical asset 152 of workflow environment 150. In another aspect, actions specified in actions area 2126 can specify communication session actions of workers 200 characterized by one or more worker interacting with another one or more worker 200 in a communication session. In one example, such communication session can include a VR session in which users interact with one another via a VR session in a VR environment. In still another example, actions presented in actions area 2126 can include movement actions of workers 200. Movement actions of users can include, e.g., movement actions such as running, walking, holding, lifting, pushing, pulling, and the like.

Recorded movement actions in actions area 2126 can specify actions in which two or more workers are working together in combined worker actions. Combined worker actions can include e.g., lifting, pushing, pulling, and the like. For classifying human action, data received from a camera IoT device can be processed. In one example, camera recorded images representing workers 200 can be processed for computing resource economized processing for classification of user actions. In one example, captured images representing workers 200 can be processed so that each worker is represented as an N jointed worker representation, i.e., a stick figure, a skeletal worker representation 200R. Parameters representing skeletal representation of one or more worker can be input as training data into a predictive model together with a supervised learning label that labels the current action of the one or more user.

Iterations of training data can be applied to the described predictive model and once trained, the described predictive model can be queried for return of an action classification that classifies a current action of the one or more user.

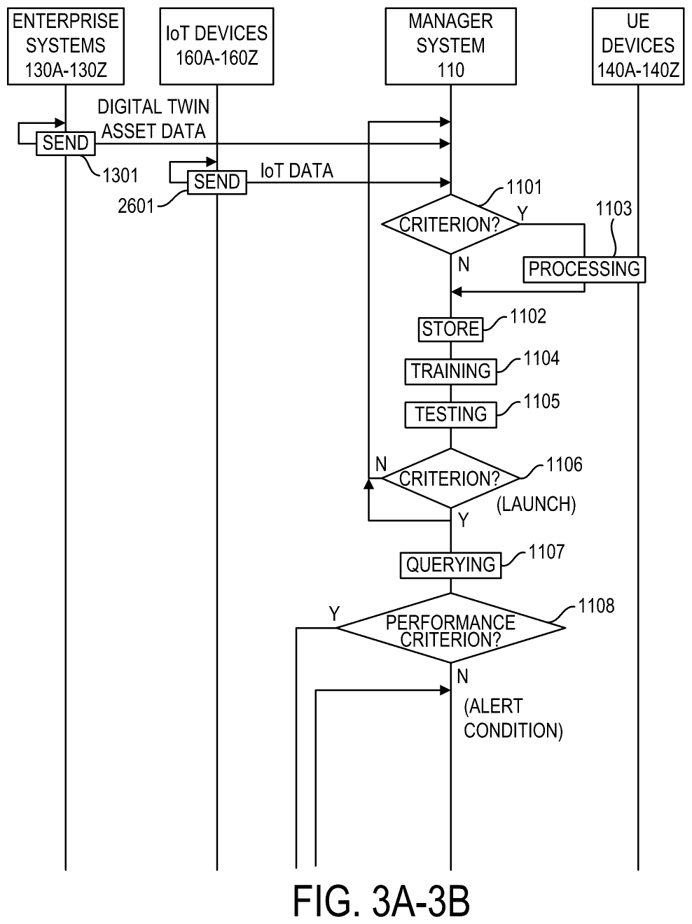

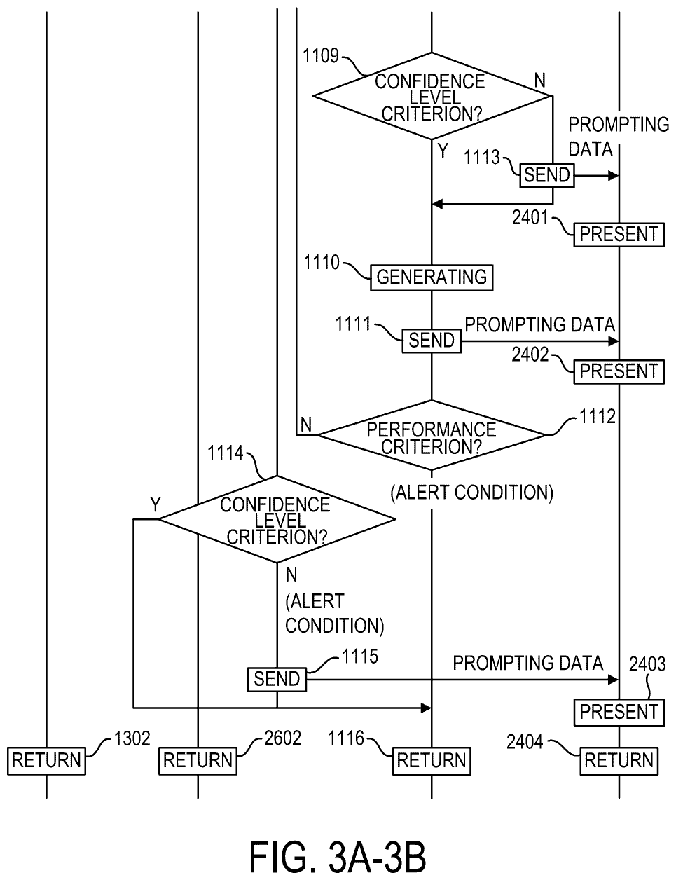

A method for performance by manager system 110 interoperating with enterprise systems 130A-130Z. IoT devices 160A-160Z of one or more workflow environment locations 150A-150Z and UE devices 140A-140Z as set forth in reference to FIGS. 3A-3B.

At block 1301, enterprise systems 130A-130Z can be sending digital twin asset data for receipt by manager system 110. Digital twin asset data can include data as described in connection with digital twin library. In one example, digital twin asset data can include data extractible from the text based document via natural language processing (NLP). Manager system 110 can run an NLP process to process data for preparation of records that are stored in data repository 108 and for other purposes. Manager system 110 can run a Natural Language Processing (NLP) process for determining one or more NLP output parameter of a message. NLP process can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter. By running of an NLP process, manager system 110 can perform a number of processes including one or more of (a) topic classification and output of one or more topic NLP output parameter for a received message, (b) sentiment classification and output of one or more sentiment NLP output parameter for a received message and/or (c) other NLP classifications and output of one or more other NLP output parameter for the received message. Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.” Manager system 110 running an NLP process can include enterprise system 110 returning NLP output parameters in addition to those specification topic and sentiment, e.g., can provide sentence segmentation tags, and part of speech tags. Manager system 110 can use sentence segmentation parameters to determine, e.g., that an action topic and an entity topic are referenced in a common sentence, for example.

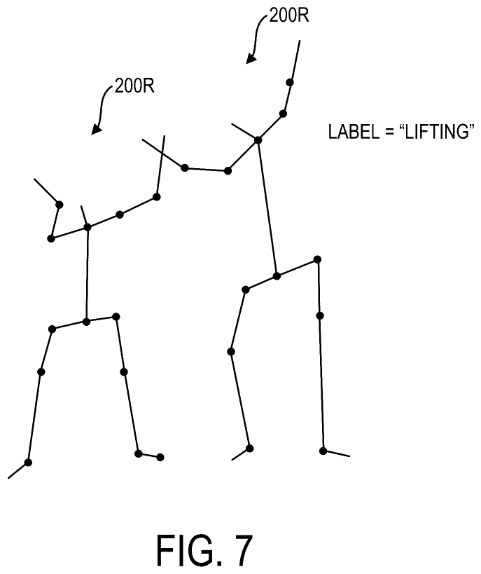

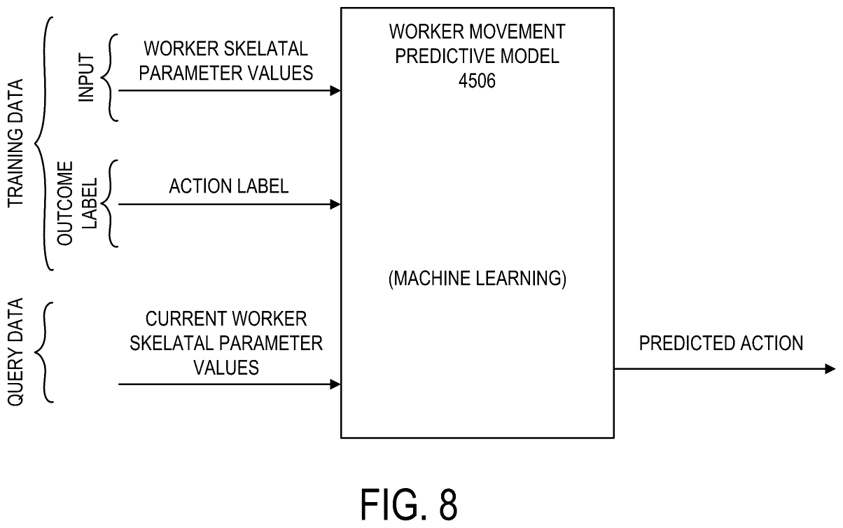

At block 2601, IoT devices 160A-160Z can be sending IoT data for receipt by manager system 110. The IoT data sent at block 2601 can include IoT sensor data that senses characteristics of one or more physical asset 152 of workflow environment 150. On receipt of the digital twin asset data iteratively sent at block 1301 and the IoT data iteratively sent at block 2601, manager system 110 can proceed to criterion block 1101. At criterion block 1101, manager system 110 can ascertain whether a criterion has been satisfied. A criterion detected for at block 1101 can be the criterion of whether received digital twin asset data and/or IoT data received prior to block 1101 is to be subject to further processing. In one example, IoT data can include unstructured data that can be subject to further processing for return of structured data. In one example, sample IoT data sent at block 2601 can include IoT data in the form of image data, e.g., point cloud 3D image data. In some use cases, when camera image data is received by manager system 110, manager system 110 at criterion block 1101 can determine that image processing is to be performed in order to transform unstructured data to structured data, which image processing can include, e.g., data reduction to generate skeletal representations of workers where workers are present in the camera image data and can perform worker action classification and/or pattern recognition using worker movement predictive model 4506 as described in FIG. 7 and/or pattern recognition predictive model 4508 as described in FIG. 8.

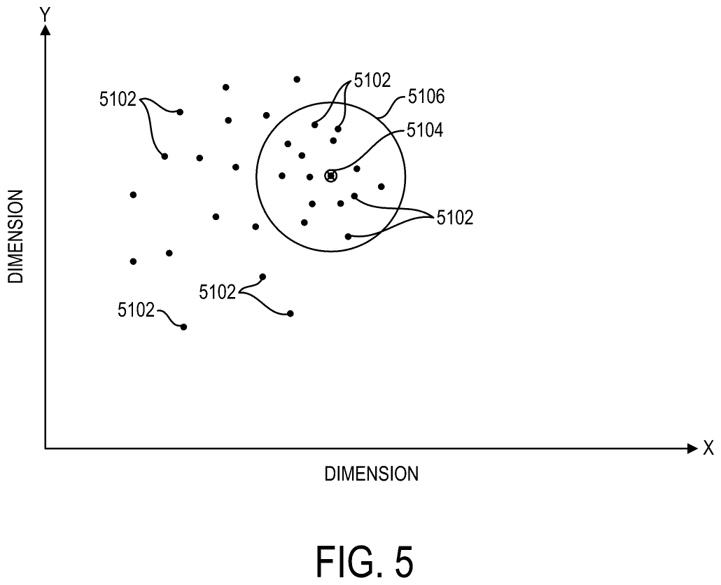

On determination at block 1101 that a criterion has been satisfied, manager system 110 can proceed to block 1103 to perform further processing of the IoT data. Further processing of IoT data provided by image data can include further processing to reduce pixel based image data into a set of points representing a human worker body in skeletal form, e.g., as set forth and described in reference to FIG. 5. In another example, processing at block 1103 of pixel based image data can include processing to detect for a pattern represented in the image data. In some use cases, manager system 110 can perform multiple classifications at processing block 1103, e.g., can return classifications of worker C and E (via locating processing), “lifting” (via movement classification using predictive model 4504), “robot” (via action classification using predictive model 4508), or worker C and E (via locating processing), “pushing” (via movement classification using predictive model 4506), “cutter” (via action classification using predictive model 4508).

On completion of block 1101 or block 1103, manager system 110 can proceed to store block 1102. At store block 1102, manager system 110 can store received digital twin asset data into digital twin library 2121 and can store received IoT data into data collection library 2124. Manager system 110 can perform storing at block 1102 after processing at block 1103 where criterion at block 1101 is satisfied and without processing at block 1103, if criterion block 1101 was not satisfied. On completion of store block 1102, manager system 110 can proceed to training block 1104.

At training block 1104, manager system 110 can train one or more predictive model, such as predictive models herein, including predictive model 4502, predictive model 4502, predictive model 4502, predictive model 4502. The one or more predictive model trained at block 1104 can include one or more predictive model trained to guide an intelligent workflow involving one or more physical asset 152. In one embodiment, the one or more predictive model trained at training block 1104 can include one or more predictive model trained to guide in intelligent workflow, wherein the intelligent workflow includes action by one or more worker such as the one or more worker 200 depicted in FIGS. 1 and 2.

Training at block 1104 in one embodiment is described with further reference to FIG. 4 showing a workflow guiding predictive model 4502. Workflow guiding predictive model 4502 can be trained with use of IoT sensor parameter values including action parameter values defining historical data stored in data collection library 2124. Workflow guiding predictive model 4502 can be trained to guide industrial setting workflows in which workers can be involved. Workflow guiding predictive model 4502 can be trained with iterations of training data and once trained, workflow guiding predictive model 4502 can be configured to provide predictions as to performance of one or more physical asset 152. In one embodiment, the one or more physical asset can be defined by an entire assembly line. In one embodiment, the one or more physical asset can be defined by a component of entire assembly line. Referring to iterations of training data for training workflow guiding predictive model 4502, workflow guiding predictive model 4502 can be trained with iterations of training data that comprise input training data and outcome training data. Workflow guiding predictive model 4502 can be queried to return outputs that define simulated operation of workflow environment 150.

For respective iterations of training data, input training data can include in reference to FIG. 4, (a) digital twin parameter values; (b) IoT parameter values at time t=T; (c) IoT parameter values a time t=T+i, and (d) IoT parameter values at time t=T+2i. IoT parameter values can be IoT parameter values from the various IoT sensor devices set forth in reference to FIG. 2, namely IoT sensor devices 1601 to 1605 distributed through workflow environment 150 as set forth in FIG. 2. An outcome defining at least one parameter value for respective iterations of outcome training data can include at least one KPI parameter value at time t=T+3i.

Manager system 110 retrieving historical data from data collection library 2124 can apply the described iterations of training data for successive values of T. Parameter values applied as input training data for training workflow guiding predictive model 4502 can include, e.g., temperature parameter values, pressure parameter values, flow rate parameter values, wattmeter parameter values, and/or setting parameter values, i.e., setting values applied for control of physical assets 1521 to 1531. In various use cases, the described setting parameter values specified in sensor data from reading sensors 1605 can include setting values that have been set by one or more worker of workers 200.

Accordingly, workflow guiding predictive model 4502 can be trained with use of training data that specifies actions by human workers 200. In some use cases, data provided by IoT sensors 160A-160Z can define asset data for storage in assets area 2125 and action data for storage are 2126. For example, the stored data value stored in data collection library 2124 can specify a setting for a physical asset of physical assets 1521 to 1531, which setting can define both an attribute of an asset as well as an action by worker.

Trained as described, workflow guiding predictive model 4502 can learn relationships between IoT parameter values at a prior time, including asset setting parameter values and KP parameter values at a later time. Thus, trained as described, workflow guiding predictive model 4502 can learn setting parameter values that impact KPI parameter values.

KPI parameter values input as training data can be derived over time iteratively in the background by manager system 110. Manager system 110 can be configured to iteratively generate and store in assets area 2125 derived KPI parameter values for workflow environment 150. Such KPI parameter values can include parameter values, e.g., (a) speed of production, (b) product quality, and (c) energy consumption, and/or (d) intermediary sensor output, and/or (e) an overall performance KPI parameter value.

For derivation of (a) a speed of production KPI parameter value metric, manager system 110 can be configured to count the number of product containers 1702 filled by robot 1531 with finished product over a time window. For counting finished containers, manager system 110 can be configured to perform image recognition of stocked and filled product containers 1702 using pattern recognition. Pattern recognition can include performing image recognition processing on captured image data captured from camera image sensor IoT device 1601 at location aa of FIG. 2, for example. In one embodiment, manager system 110 running an image recognition process to examine spatial image data representing a feature of interest can include manager system 110 employing pattern recognition processing using one or more of e.g., feature extraction algorithms, classification algorithms, and/or clustering algorithms. In one embodiment, manager system 110 running image recognition process 114 can include performing of digital image processing. Digital image processing can include, e.g., filtering, edge detection, shape classification, optical character recognition (OCR), and/or encoded information decoding.

Manager system 110 can derive a (b) product quality metric by processing image data captured from camera image sensor IoT device 1601 at location aa. In one embodiment, manager system 110 can perform pattern recognition to detect for defects in completed product 1701 and/or product containers 1702. For example, manager system 110 can perform pattern recognition to detect for defects such as variations in thickness, cracks, discolorations, and the like. Manager system 110 can product a count of defects for each produced containerized product, and can provide the defect count as the quality parameter, with the count “zero” defects indicating the highest quality.

Manager system 110 can be configured to perform derivation of a power consumption metrics by aggregating wattmeter readings from respective reading IoT sensors 1605 disposed at respective physical assets 1521 to 1531 of workflow environment 150 over a given time window.

In some scenarios, manager system 110 can apply an intermediate sensory IoT sensor output as a KPI parameter value as training data for application to predictive model 4502 as outcome data. For example, a flow rate as detected by flow sensor 1604 at fluid channel 1528 can be applied as a KPI parameter value. In some embodiments, manager system 110 can derive an overall performance score of workflow environment 150 and use the derived performance score as a KPI parameter value for application as outcome data in iterations of training data for training workflow guiding predictive model 4502.

In one embodiment, manager system 110 can apply Eq. 1 below for deriving an overall performance score KPI parameter value for workflow 150, including for one more physical asset 152 therein.

$$S = F 1 W 1 + F 2 W 2 + F 3 W 3 + F 4 W 4 \qquad ( Eq . 1 )$$

Where S is the overall performance score, where F1, F2, F3, and F4 are KPI parameter value factors contributing to the overall performance score and W1, W2, W3, and W4 are weights associated to the various factors.

In one embodiment, factor F1 can be a speed factor as set forth herein above wherein manager system 110 can assign scale scoring values applied under factor F1 in dependence on the speed of production. In one embodiment, factor, F2 can be a product quality factor wherein manager system 110 can scale scoring values under factor F2 based on detected quality, e.g., manager system 110 can reduce scoring values from a maximum of 1.0 in dependence on a number of defects detected, and, in one embodiment, manager system 110 can apply scoring values under factor F3 in dependence on detected energy consumption over a time window. For example, manager system 110 can inversely scale scoring values under factor F3 in dependence on determined energy consumption over a time window. In reference to Eq. 1, manager system 110 can apply scoring values under factor F4 in dependence on deviation of an intermediary sensor value from a nominal value, e.g., flow rate at fluid channel 1528 in dependence on a deviation of the detected flow rate from a nominal value. For example, manager system 110 can apply scoring value under factor F4 of 1.0 where flow rate is precisely on a nominal value and can lower the values from 1.0 in dependence on the deviation from the nominal value, either higher or lower.

Workflow guiding predictive model 4502, once trained, can be responsive to query data. In one example, query data for querying workflow guiding predictive model 4502 can include current IoT sensor parameter values at time t=C, t=C−1, and t=C−2i which can include sensed control settings of various one or more physical asset 152. In response to the applied query data, workflow guiding predictive model 4502 can output predicted at least one KPI parameter values at time t=C+i where the time t=C is the current time, the time t=C−i is a historical time one time period prior to the current time, and the time t=C−2i is an historical time two time periods from the current time. On completion of training block 1104, manager system 110 can proceed to testing block 1105.

At testing block 1105, manager system 110 can test one or more trained predictive model, e.g., the predictive model defined by workflow guiding predictive model 4502. For testing of workflow guiding predictive model 4502, manager system 110 can compare a predicted at least one KPI parameter value to one or more current real time derived KPI parameter value. For testing of workflow guiding predictive model 4502, manager system 110 can apply as query data historical IoT parameter values from the times t=C−3i, t=C−2i, and t=C−i, so that workflow guiding predictive model 4502 outputs a prediction as to predicted KPI parameter values at time T=C. i.e., the current time. Manager system 110 at testing block 1105 can compare a predicted test at least one KPI parameter values output by workflow guiding predictive model 4502 under the described test to an actual at least one KPI parameter values derived by manager system for the current time t=C.

Manager system 110 can compare the actual predicted KPI parameter values to the predicted KPI parameter values and can qualify workflow guiding predictive model 4502, where workflow guiding predictive model 4502 exhibits a threshold level of accuracy. At criterion block 1106, manager system 110 can apply the described criterion wherein workflow guiding predictive model 4502 is qualified for launch into production when manager system 110 determines that workflow guiding predictive model 4502 is exhibiting an acceptable level of accuracy.

When manager system 110 at criterion block 1106 determines that workflow guiding predictive model 4502 is exhibiting an acceptable level of predictive accuracy, manager system 110 can proceed to launch workflow guiding predictive model 4502 into production, wherein workflow guiding predictive model 4502 simulates performance of one or more physical asset 152 and guides workflow of workflow environment 150, including worker actions within workflow environment 150. Manager system 110 can scale a confidence level to workflow guiding predictive model 4502 in dependence on the determined predictive accuracy.

When manager system 110 at block 1106 determines that the described criterion is not satisfied, manager system 110 can return to a stage prior to criterion block 1101 to iteratively receive new IoT data, and perform blocks 1101 to 1106 to iteratively train and test workflow guiding predictive model 4502 and in various use cases, additional predictive models 4502 until the one or more simulation workflow model is qualified for production launch.

Further in reference to block 1106, it is highlighted that even where manager system 110 at criterion block 1106 determines that workflow guiding predictive model 4502 is exhibiting a threshold level of predictive accuracy and therefore qualified for production launch, manager system 110 can iteratively return to a stage preceding criterion block 1101 so that the loop of blocks 1101 to 1106 is ongoing and iterative even where workflow guiding predictive model 4502 has been qualified for launch. In some use cases, criterion block 1106 can be configured so that workflow guiding predictive model 4502 is replaced and upgraded where a newly trained instance of workflow guiding predictive model 4502 exhibits from testing block 1106 an increased accuracy performance level relative to the currently launched version. In such an instance, manager system 110 can be configured to replace workflow guiding predictive model 4502 with the new instance of workflow guiding predictive model 4502. In another example, releases of a new workflow guiding predictive model 4502 can be governed by policy wherein changes to model data of digital twin library 2121 trigger on qualification at block 1106 the release of a new instance of workflow guiding predictive model 4502 which can be trained with training data defined by model data of digital twin library 2121.

On launch of workflow guiding predictive model 4502, manager system 110 can proceed to querying block 1107. In production, with workflow environment 150 producing product, manager system 110 at querying block 1107 can query workflow guiding predictive model 4502 for return of predictions as to a predicted at least one KPI parameter value of workflow environment 150 and one or more physical asset 152 therein at a subsequent time period from a current time, C, t=C+i. On performance of querying at block 1107, manager system 110 can proceed to performance criterion block 1108, wherein manager system 110 determines whether the predicted performance of workflow environment 150 satisfies a performance threshold indicative of satisfactory performance of workflow environment 150.

Where at block 1108 it is determined that workflow environment 150 is predicted to exhibit unsatisfactory performance based on one or more predicted KPI, manager system 110 can set an alert condition at block 1108 and manager system 110 can proceed to confidence level criterion block 1109. When an alert condition has been determined, manager system 110 can subject newly received IoT sensor input data received from IoT devices 160A-160Z at one or more workflow environment location 150A to 150Z to tagging in order to tag the received IoT sensor data as being received under an alert condition.

At confidence level criterion block 1109, manager system 110 as part of detecting and characterizing an alert condition can perform an evaluation of a confidence level of workflow guiding predictive model 4502. Manager system 110 performing confidence level criterion block 1109 can apply the technique described in reference to testing block 1105 in which performance, in terms of accuracy, of workflow guiding predictive model 4502 was tested. By comparison of an actual currently derived at least one KPI parameter value to a predicted at least one KPI parameter value predicted based on application of historical IoT parameter values as query data into workflow guiding predictive model 4502, manager system 110 can evaluate a predictive performance of workflow guiding predictive model 4502, and can scale a confidence level to workflow guiding predictive model 4502 accordingly.

Manager system 110 at confidence level criterion block can assign a confidence level to workflow guiding predictive model 4502 in dependence on a deviation of at least one predicted KPI parameter value in reference to an actual currently observed at least one KPI parameter value. Embodiments herein recognize that while workflow guiding predictive model 4502 can be qualified for launch, workflow environment 150 can subsequently encounter anomalous conditions such that predictive accuracy of workflow guiding predictive model 4502 can be negatively impacted.

Embodiments herein can employ the prediction accuracy performance of workflow guiding predictive model 4502 as an input derivation of prompting data for prompting workers to take action in respect to an anomalous condition where the anomalous condition is detected by way of comparing actual observed KPI parameter values to one or more predicted KPI parameter value. On determination at block 1112 that the confidence level of workflow guiding predictive model 4502 has fallen below a threshold level, manager system 110 can proceed to send block 1113.

At send block 1113, manager system 110 can send prompting data to groups of workers 200 at respective UE devices of UE devices 140A-140Z. At send block 1114, prompting data can be sent to UE devices of UE devices 140A-140Z associated to groups of two or more workers within workflow environment 150, e.g., to all workers 200 of regions A-E as shown in FIG. 2. Prompting data can include text based prompting data specifying an action and/or graphics data, e.g., rendered asset model data of asset model area 2122. UE devices of UE devices 140A-140Z can present the prompting data at present block 2402. Embodiments herein recognize that human involvement and collaboration can benefit intelligent workflows in terms of handling complex decision-making, addressing exceptions, interpreting data, driving continuous improvement, fostering collaboration among stakeholders, and ensuring ethical considerations are taken into account. Embodiments herein recognize that humans bring unique skills, judgment, and creativity that complement the capabilities of AI technologies, leading to more effective and responsible workflow implementation. In response to the received prompting data, UE devices of UE devices 140A-140Z can present at present block 2401, the described prompting data prompting collaborative action among groups of workers 200 within workflow environment 150. In one embodiment, the prompting data presented at block 2401 can be presented within VR headsets 1402 of the respective workers 200 within workflow environment 150.

As explained in reference to block 1113 (and block 1115 referenced later herein), embodiments herein can prompt workers to collaborate responsively to a determination that a simulation is not operating with a satisfactory level of predictive accuracy. Embodiments herein recognize that a predictive model's inability to produce sufficiently accurate predictions can indicate the presence of an anomalous condition, remediation of which can benefit from human collaboration.

For example, worker users may use VR devices such as VR headset to view one or more digital twin model 2122 stored in digital twin library 2121 virtually rendered in VR space. Worker users may interact with the one or more asset model being rendered on a VR device defining a UE device of UE devices 140A-140Z by touching or selecting one or more components that are rendered, as a method for teleoperation of one or more physical asset 152 represented by a VR rendering. Worker users may view and interact with multiple renderings of asset models using respective VR devices. During VR collaboration, the human workers can perform teleoperation action on one or more physical asset 152 having operation being simulated by a current simulation, verbal or gesture-based command to the intelligent workflow system, and accordingly, the intelligent workflow can be executed.

In one use case, prompting data presented at block 2401 can include prompting data that permits workers 200 to view performance data of workflow environment 150 operating in a state having a threshold level of similarity with respect to the current state. Referring to the clustering analysis diagram of FIG. 5, manager system 110 can record historical IoT parameter values at historical timeslots and/or historical KPI parameter values associated to such IoT parameter values as dimensions representing historical states of workflow environment 150. Referring to FIG. 5, the data points 5102 represent historical states of workflow environment 150, and data point 5104 represents a current state of workflow environment 150. For filtering and selecting visualizations for presentment to a workers 200, manager system 110 can select historical states having a threshold satisfying level of similarity with a current state of workflow environment 150, as measured by Euclidian distance. In reference to the clustering analysis diagram of FIG. 5, manager system 110 can select the historical states of workflow environment 150 of cluster 5106 within a threshold Euclidian distance of the current state of workflow environment 150 as the historical states for review by workers 200. Manager system 110 can present user interface controls to workers 200 facilitating the viewing of IoT parameter values and/or KPI parameter values of historical states having a threshold level of similarity to the current state. Manager system 110 can present controls permitting workers to observe impact on performance of actions with respect to workflow environment 150 in states identified as having a threshold level of similarity to the current state. In the clustering analysis diagram of FIG. 5, historical states of workflow environment 150 are represented by two dimensions, e.g., first and second IoT parameter values, first and second KPI parameter values, or one IoT parameter value and one KPI parameter value. In another example the clustering analysis employed for computing resource economization and filtering and selecting candidate worker actions can be scaled to N dimensions. In another aspect, manager system 110 can employ clustering analysis according to the description of FIG. 5 for comparing one or more asset model of workflow environment 150 to historical instances of the one or more asset model of workflow environment, and selecting and identifying relevant historical asset models based on such clustering analysis. In such an embodiment, manager system 110 can restrict the presentment historical IoT parameter values and/or KPI parameter values to historical IoT parameter values and/or KPI parameter values wherein a qualified asset model was driving predictions output by workflow guiding predictive model 4502.

On completion of send block 1113, manager system 110 can proceed to generating block 1110. Manager system 110 can also proceed to generating block 1110 on the determination at block 1109 that workflow guiding predictive model 4502 is accurately producing predictions.

At generating block 1110, manager system 110 can generate prompting data for prompting one or more worker 200 at one or more regions A through E as shown in FIG. 2 to perform action. In one use case, prompting data generated at generating block 1110 can be extracted from a decision data structure as shown in Table A in which maintenance actions are mapped to different respective KPI parameter values. An example decision data structure is shown in Table A, wherein the referenced KPIs are (KPIa) speed of production, (KPIb) product quality, and (KPIc) energy consumption, (KPId) intermediary sensor output, flow rate at fluid channel 5128 (e) an overall performance KPI parameter, determined using Eq. 1, as described in reference to the described KPIs (a)-(e) hereinabove.

TABLE A

| | | Prompting data | Text based | |
|---|---|---|---|---|
| Row | Condition | sent to | prompting data | Description |
| 1 | KPIa <= th1 | Worker assigned to | XXXX XX | Text prompting data |
| | (speed of | region E; Worker | XXXX; | sent to worker at |
| | production) | assigned to region A; | XXXX | Region E to adjust |
| | | Worker assigned to | XXXX; | robot controls; text |
| | | region B | XXXX | prompting data to |
| | | | XXXX | worker at Region A to |
| | | | | increase load rate; text |
| | | | | prompting data to |
| | | | | worker at Region B to |
| | | | | increase load rate. |
| 2 | KPIb <= th2 | Worker assigned to | XX XX | Text prompting data |
| | (quality) | region E; Worker | XXXX; XX | sent to worker at |
| | | assigned to region A; | XXXX; | Region E to adjust |
| | | Worker assigned to | XX XXXX | roller controls; text |
| | | region B | | prompting data to |
| | | | | worker at Region A to |
| | | | | change feedstock; text |
| | | | | prompting data to |
| | | | | worker at Region B to |
| | | | | change feedstock. |
| 3 | KPIc <= th3 | Worker assigned to | XXXXX | Text prompting data |
| | (energy | region C | | sent to worker at |
| | consumption) | | | Region C to reduce |
| | | | | heater setting. |
| 4 | KPId <= th4 | Worker assigned to | XX XXXX | Text prompting data |
| | (flow rate at fluid | region E | XX | sent to worker at |
| | channel 5128)_{—} | | | Region E to increase |
| | | | | valve opening at pump |
| | | | | 1528P. |
| 5 | KPIe <= th5 | Worker assigned to | XX XX; | Text prompting data |
| | (overall | region A; Worker | XXXX | sent to workers at |
| | performance) | assigned to region B; | XXXXX; | Regions A-E to |
| | | Worker assigned to | XXXXX | perform different |
| | | region C; Worker | XX; XX | calibration routines. |
| | | assigned to region D; | XX XX; | Text prompting data |
| | | Worker assigned to | XXXXX | sent to worker at |
| | | region E | XXXXX | Region C and worker |
| | | | | at Region E to lift |
| | | | | robot 1531 for |
| | | | | inspection and |
| | | | | unjamming. |

On completion of generating block 1109 which can be performed with use of the decision data structure of Table A, manager system 110 can proceed to send block 1111. At send block 1111, manager system 100 can send generating prompting data to the relevant workers. Prompting data can include text based prompting data that specifies an action and/or graphics data, e.g., a rendered asset model representing one or more physical asset 152. At send block 1111, manager system 110 can send prompting data for presentment on UE devices of respective workers 200. In reference to Table A, it can be seen that workers can be addressed for messaging based on their assigned region which can define an assigned role. In some use cases multiple different users (e.g., who work at different shifts) can serve in a common roll and can be classified by the role. Training data for training predictive models defined by worker data can specify worker roll and/or the worker ID. Data repository 108 can store messaging addresses of all workers so that such workers can be messaged based on individual ID and/or by role. In another aspect, infrastructure defining network 190 located at workflow environment 150 can be provisioned to provide locating services so that locations of individual workers 200 can be tracked at all times and recorded within data repository 108. In one use case, radio signal data sent by UE device smartphones of respective workers 200 and defining IoT sent data (block 2601) can be processed at processing block 1103 to resolve a current location of the worker, which location can be stored at block 1102.

Responsively at block 2402, the described prompting data can be presented, e.g., by presenting text based data as summarized in table A on respective UE devices of the respective workers 200.

On completion of block 1112, manager system 110 can proceed to performance criterion block 1112. At performance criterion block 1112, manager system 110 can determine whether a current alert condition has ended. For determination of whether a current alert condition has ended, manager system 110 at performance criterion block 1112 can examine currently derived KPI parameter values specifying current performance of workflow system 150 and can determine that an alert condition has ended when the KPI parameter values indicate that workflow environment 150 is performing satisfactorily. When an alert condition is active, manager system 110 can be tagging received IoT data sent at block 2601 as being received under an alert condition.

On determination that the alert condition has not ended, manager system 110 can return to a stage preceding confidence level criterion block 1109 and can iteratively perform the loop of blocks 1109 to 1112 until a time that the current alert condition has ended. On the determination at block 1112 that an alert condition has ended, manager system 110 can proceed to return block 1116. At return block 1116, manager system 110 can return to a stage prior to querying block 1107 and can iteratively perform the loop of blocks 1107 to 1116 (with possible branches) for a deployment period of manager system 110. For a time during iterative performance of block 1109 that a confidence level of workflow guiding predictive model 4502 is determined to be below the predictive accuracy performance threshold, manager system 110 can perform tagging of incoming IoT data sent at block 2601 to indicate that predictive accuracy performance of predictive model 4502 is determined to be below a threshold.

In one use case in reference to prompting data generating block 1110, it was described that manager system 110 can generate prompting data via look up of prompting data in reference to decision data structure as set forth in reference to Table A in dependence on an output of workflow guiding predictive model 4502. In other use cases, manager system 110 at generating block 1109 for generating prompting data can employ alternative use of one or more predictive model trained by training data with use of machine learning. In alternative use cases, manager system 110 generating prompting data at block 1109 can include manager system 110 generating prompting data in dependence on querying of workflow guiding predictive model 4502.

In reference to FIG. 4, it was described that querying a workflow guiding predictive model 4502 can include querying workflow guiding predictive model 4502 with query data that comprises IoT parameter values over successive time periods T=C−i, T=C−2i. Embodiments herein recognize that because workflow guiding predictive model 4502 is trained on IoT parameter values in reference to KPI parameter values, workflow guiding predictive model 4502 can also and alternatively be queried with use of KPI parameter values defining one or more targeted KPI parameter value. Accordingly, in one use case at block 1109, manager system 110 can query workflow guiding predictive model 4502 with use of one or more KPI parameter value defining a targeted one or more KPI parameter value. On being queried with the described KPI parameter value, workflow guiding predictive model 4502 can return a prediction that specifies IoT parameter values, including setting parameter values over successive time periods that are predicted to result in the one or more query KPI parameter value being realized. At generating block 1109, manager system 110 can derive prompting data in dependence on the generated output predicted IoT parameter values output from workflow guiding predictive model 4502 as a result of being queried with the described one or more target KPI parameter value input into workflow guiding predictive model 4502 as query data.

Manager system 110 can employ a decision data structure as described in reference to the decision data structure of Table B, in order to resolve the predicted output parameter values (for IoT sensors IoTa, IoTb, IoTc, IoTd . . . ) for derivation of text based prompting data for presentment to relevant workers within workflow environment 150.

TABLE B

| | IoTa | IoTb | IoTc | IoTd | | | |
|---|---|---|---|---|---|---|---|
| | parameter | parameter | parameter | parameter | | Workers | Text based |
| Row | value range | value range | value range | value range | . . . | messaged | messages |
| 1 | XX | XX | XX | XX | . . . | XX | XX |
| 2 | XX | XX | XX | XX | . . . | XX | XX |
| 3 | XX | XX | XX | XX | . . . | XX | XX |
| . . . | . . . | . . . | . . . | . . . | . . . | . . . | . . . |

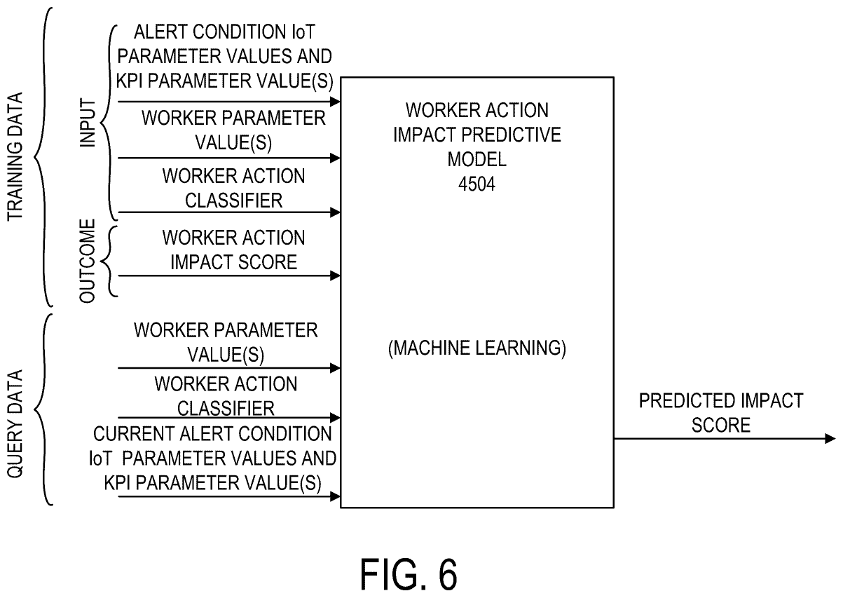

In another use case, prompting data generating at generating block 1110 can include generating prompting data in dependence on query of worker action impact predictive model 4504 set forth in reference to FIG. 6. Worker action impact predictive model 4504 can be trained with iterations of training data. Iterations of training data for training worker action impact predictive model 4504 can include training data that comprises input training data and outcome training data. Iterations of input training data for training worker action impact predictive model 4504 can be timed to instances where one or more worker action was recorded. Worker action can include worker action to change a setting of a physical asset 152 and/or worker movement action where one or more worker performs a movement in respect to one or more physical asset of workflow environment 150. All recorded data recorded into data collection library 2124 can be timestamped.

Recorded worker actions used for training of worker action impact predictive model 4504 can include, e.g., control setting worker actions and movement worker actions, wherein one or more user performs a movement action in reference to workflow environment 150, e.g., workflow action in respect to one or more physical asset 152. Worker action input training data for training worker action impact predictive model 4504 can include, for every worker action recorded during an alert condition (a) alert condition IoT parameter values present at the time of the recorded worker action, (b) worker parameter values specifying, e.g., a role of the relevant worker or workers taking action and/or identifiers for such workers, and (c) worker action classifier specifying action of one or more worker, e.g., a setting change action, a movement action. Worker movement actions can be detected with use of worker movement predictive model 4506 described in reference to FIG. 8.

Worker action classifiers can include an action specifier, e.g., changing a setting to a new value and asset identifier, e.g., specifying the one or more physical asset 152 subject to action. An iteration of training data can also include an outcome on which the input training data is trained on. The outcome training data in an iteration of training data for training worker action impact predictive model 4504 can include a worker action impact score. In one illustrative use case, input on outcome training data of a training data set can be derived using an overall KPI performance score in a manner set forth in reference to Eq. 1, wherein an impact score can be derived by comparison of the overall KPI score of workflow environment 150 using Eq. 2.

$$SI = S 2 - S 1 \qquad ( Eq . 2 )$$

Where S1 is the impact score of the worker action, S1 is the overall KPI score S at the time of the recorded action associated to the iteration of training data and S2 is the overall KPI score S of workflow environment 150 at a subsequent time period after the worker action recordation time. On a scale of 0 to 1.0, manager system 110 in reference to Eq. 2 can scale scoring values for a predicted impact to scaled values above 0.5, where observed performance of workflow environment 150 improves subsequent to the historical action and can scale scoring values to scaled values below 0.5, where observed KPI performance of workflow environment 150 declines subsequent to the worker action. Trained as described, worker action impact predictive model 4504 can learn a relationship between worker actions and impact on workflow environment 150 comprising one or more physical asset 152. Worker action impact predictive model 4504, once trained, can be subject to query using query data for return of predictions as to the outcome of performing specified candidate worker actions in respect to workflow environment 150.

At prompting data generating block 1110 in one embodiment, manager system 110 can query worker action impact predictive model 4604 with various candidate query datasets, wherein each of the candidate query datasets specifies a different candidate worker action that may be performed. Each candidate dataset can include worker parameter values specifying worker roles and/or identifiers associated to the action, worker action classifiers specifying the type of action, optionally a value associated to the action, and one or more physical asset associated to the action as well as current alert condition IoT sensor parameter values. With each new candidate query data set applied, worker action impact predictive model 4504 can output a prediction that indicates the predicted impact score associated to the candidate action. Manager system 110 can rank the candidate worker actions according to their predicted impact scores and can output an ordered list of ranked candidate actions.

Where at least one predicted impact score S1 associated to a candidate worker action satisfies a threshold impact score, manager system 110 can generate prompting data that prompts one or more worker to take the action associated to the N highest ranking candidate worker actions output in the ordered list. The prompting data can be provided by text based data that specifies the N highest ranking candidate action.

In one aspect, the one or more worker action used for training worker action impact predictive model 4604 can include worker actions that involve combined actions of a group of two or more users. Worker actions involving groups of two or more workers can include movement actions of the two or more users, e.g., two or more workers lifting robot 1531, two or more workers pushing the physical asset defined by cutter 1530, two or more workers pulling the physical asset defined by roller 1529, and the like. For computing resource economization, manager system 110 can process reduced weight image data for resolving actions of one or more worker.

FIG. 7 depicts skeletal representations 200R of first and second workers 200, wherein one of the represented workers can be the depicted worker 200 at region E, and a second of the depicted workers can be the depicted worker at region C of FIG. 2. Image data indicated in FIG. 7 can be obtained with use of camera image sensor IoT device 1601 at location aa.

In one use case under an alert condition, the worker 200 at region C can move to region E to assist the worker 200 depicted at region E and each described first and second users can work together to lift physical asset defined by robot 1531 as depicted by the skeletal representation view of FIG. 7, wherein each of the workers 200 is represented as a set of 12 joints. Reduced image data depicted in FIG. 7 can be applied as query data for query of worker movement predictive model 4606 that can be previously trained using training data that comprises worker skeletal parameter values under various conditions.

Referring to FIG. 8, worker movement predictive model 4506 can be trained over time with iterations of training data, wherein each iteration of training data comprises a training data iteration input and a training data iteration outcome label. The training data iteration input can comprise worker skeletal parameter values specifying skeletal representation of one or more user as depicted in FIG. 7, and the outcome label can be an administrator user observed action defined by the skeletal representation. In further reference to worker movement predictive model 4506 as shown in FIG. 8 iterations of input training data can be trained on iterations of outcome label training data, wherein the outcome label training data is an action label. The action label, in one embodiment, can be a label manually assigned by an administrator user on observation of the training data input data. For example, an administrator user observing a skeletal representation of one or more user worker can assign labels to the skeletal representations such as lifting, pushing, pulling in dependence on particular skeletal view. For increased accuracy, worker movement predictive model 4506 can accommodate as training data sequences of skeletal views over time, e.g., within time windows of a predetermined number of seconds. Trained as described, worker movement predictive model 4506 is able to respond to query data. Query data for query of worker movement predictive model 4506 can include a skeletal representation of one or more worker, e.g., the worker representation data depicted in FIG. 7. Worker movement predictive model 4506, once trained, can be subject to query data defined by a current skeletal representation of a current scene. When query data is applied to worker movement predictive model 4506, worker movement predictive model can output a predicted action associated to the skeletal worker input query data. Where worker movement predictive model 4606 has been trained using sequential movement skeletal representations of one or more worker, the query data for query of worker movement predictive model 4506 can correspondingly include sequences of skeletal representations of one or more worker.

For computing resource economization, manager system 110 can employ clustering analysis for filtering and selecting candidate worker action classifiers used for querying worker action impact predictive model 4504. Referring to the clustering analysis diagram of FIG. 5, manager system 110 can record historical IoT parameter values at historical timeslots and/or historical KPI parameter values associated to such IoT parameter values as dimensions representing historical states of workflow environment 150. Referring to FIG. 5, the data points 5102 represent historical states of workflow environment 150, and data point 5104 represents a current state of workflow environment 150. For filtering and selecting candidate worker action classifiers used for querying worker action impact predictive model 4504, manager system 110 can select for query of worker action impact predictive model 4504 worker actions performed with workflow environment 150 defined by one or more physical asset 152 in a state having a threshold satisfying level of similarity with a current state of workflow environment 150, as measured by Euclidian distance, and resulting in a threshold satisfying impact score, as measured according to Eq. 2. In reference to the clustering analysis diagram of FIG. 5, manager system 110 can select qualifying actions associated to historical states of workflow environment within cluster 5106 within a threshold Euclidian distance of the current state of workflow environment 150 as represented by data point 5104. In the clustering analysis diagram of FIG. 5, historical states of workflow environment 150 is represented by two dimensions, e.g., first and second IoT parameter values, first and second KPI parameter values, or one IoT parameter value and one KPI parameter value. In another example, the clustering analysis employed for computing resource economization and filtering and selecting candidate worker actions can be scaled to N dimensions.

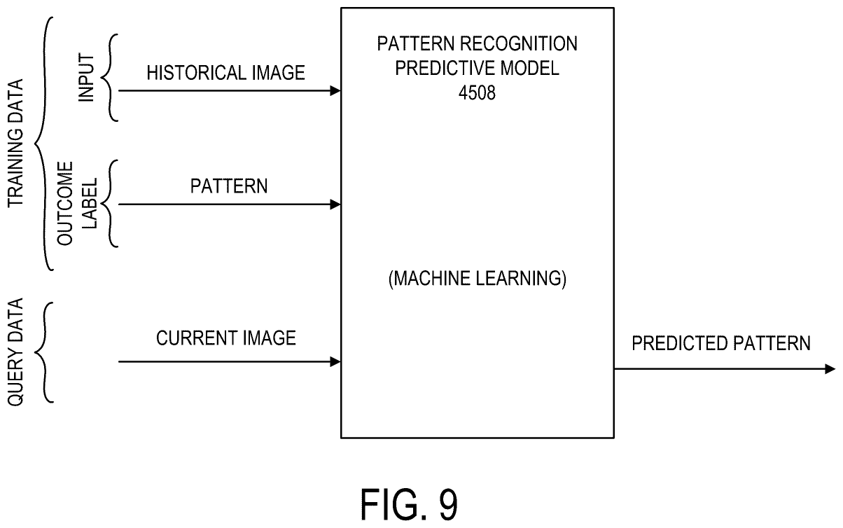

Referring to FIG. 9, pattern recognition predictive model 4508 can be trained over time with iterations of training data, wherein each iteration of training data comprises a training data iteration input and a training data iteration outcome label. The training data iteration input can comprise image data representing a pattern to be recognized and the outcome label can be an administrator user observed pattern defined by the representation. Patterns to be recognized in reference to workflow environment 150 can include, e.g., cracks or other defects on a finished product or packaged product container as represented in image data captured with use of camera image sensor IoT device 1601 at location aa of FIG. 2. Patterns to be recognized in reference to workflow environment 150 can additionally or alternatively include physical asset objects defining patterns, e.g., “robot”, “cutter”, and the like. In further reference to pattern recognition predictive model 4508 as shown in FIG. 9 iterations of input training data can be trained on iterations of outcome label training data, wherein the outcome label training data is a pattern label. The pattern label, in one embodiment, can be a label manually assigned by an administrator user on observation of the training data input data. For example, an administrator user observing a skeletal representation of one or more user worker can assign labels to observed input data such as “crack”, “dimple”, “spot”, “gap”, “robot”, “cutter”, “heater”, “valve”, etc.

Returning again to performance criterion block 1108, manager system 110 at performance criterion block 1108 can ascertain via querying at block 1107 of workflow guidance guiding predictive model 4502 whether workflow environment 150 is predicted to exhibit KPI parameter values indicative of a satisfactory level of performance. On the determination at block 1108 that workflow environment 150 is predicted to exhibit a threshold satisfying level of performance, manager system 110 can proceed to confidence level criterion block 1114. At confidence level criterion block 1114, manager system 110 can ascertain whether workflow guiding predictive model 4502 is exhibiting a threshold satisfying level of predicted performance.

At block 1114, manager system 110 can apply the technique for evaluation evaluating predicted performance of workflow guiding predictive model 4502 as described in reference to block 1105 and block 1109. Embodiments herein in reference to block 1114 recognize that while workflow environment 150 can be operating satisfactorily, latent anomalous conditions can be present which can be detected at block 1114. When manager system 110 determines that workflow guiding predictive model 4502 is not producing predictions with acceptable accuracy, manager system 110 can activate an alert condition. With the alert condition active, manager system 110 can tag incoming IoT data received responsively to send block 2601 to specify that the incoming IoT data has been received with the alert condition active. At a subsequent iteration of block 1114 (or block 1109), manager system 110 can remove the alert condition based on predictive accuracy responsively to the determination at block 1114 (or block 1109) that workflow guiding predictive model 4502 is producing predictions having satisfactory accuracy.

In one embodiment, on determination that workflow guiding predictive model 4502 is not providing predictions with a threshold satisfying level of accuracy, manager system 110 can proceed to send block 1115. At send block 1115, manager system 110 can send prompting data for presentment to UE devices of UE devices 140A-140Z. At send block 1115, manager system 110 can send prompting data in the manner of sending prompting data at block 1113.

As explained in reference to block 1113, manager system 110 can prompt workers to collaborate responsively to a determination that a simulation is not operating with a satisfactory level of predictive accuracy. Embodiments herein recognize that a predictive model's inability to produce sufficiently accurate predictions can indicate the presence of an anomalous condition, remediation of which can benefit from human collaboration.

For example, responsively to manager system 110 sending prompting data worker users may use VR devices such as VR headset to view one or more digital twin models of one or more digital twin asset 2122 virtually rendered in VR space. Worker users may interact with the one or more asset model being rendered on a VR device defining a UE device of UE devices 140A-140Z by touching or selecting one or more components that are rendered, as a method for teleoperation of one or more physical asset 152 represented by a VR rendering. Worker users may view and interact with multiple renderings of asset models using respective VR devices. During VR collaboration, the human workers can perform teleoperation action on one or more physical asset 152 having operation being simulated by a current simulation, verbal or gesture-based command to the intelligent workflow system, and accordingly the intelligent workflow can be executed.

On completion of send block 1114, manager system 110 can proceed to return block 1116 and can perform the actions described previously in reference to return block 1116. On the determination at block 1114 that workflow guiding predictive model 4502 is satisfactorily providing predictions with sufficient accuracy, manager system 110 can proceed to return block 1116. At return block 1116, manager system 110 can perform the actions described previously in reference to return block 1116. Enterprise systems 130A-130Z can iteratively perform the loop of blocks 1301 and 1302 for a deployment period of enterprise systems 130A-130Z. IoT devices 160A-160Z can iteratively perform the loop of blocks 2601 to 2602 during the deployment period of IoT devices. UE devices 140A-140Z can iteratively perform the loop of blocks 2401 to 2404 during a deployment period of UE devices 140A-140Z.

In reference to generating block 1110, send block 1113, and send block 1115 it can be seen that prompting data sent to one or more worker can change and depend on characteristics of a detected alert condition. Where an alert condition is based on what one or more TPI parameter value failing to satisfy a threshold, prompting data can be generated and sent in accordance with the generating process associated to block 1110. Where an alert condition is been detected in dependence on a predictive accuracy of one or more predictive model failing to satisfy an accuracy performance threshold, prompting data can be generated in accordance with the process associated to block 1113 or block 1115. In accordance with block 1113 and block 1115 prompting data can be sent to prompt for collaboration between groups of workers. In accordance with prompting data generated at generating block 1110, prompting data can be generated in accordance with the process described in reference to Table A, Table B, and/or querying of worker action impact predictive model 4504.

Accordingly, there is set forth herein, according to one embodiment, storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment, wherein the detecting, in dependence on the performing the simulation that an alert condition is present in the workflow environment includes determining that the alert condition is characterized by one or more predicted KPI parameter value predicted by the simulation failing to satisfy a performance threshold (e.g., block 1108), and ascertaining that the alert condition is characterized by a predictive accuracy of the simulation failing to satisfy an accuracy threshold (e.g., block 1109), wherein the prompting one or more worker within the workflow environment to take action in response to the detecting that the alert condition is present in the workflow environment includes generating first prompting data (e.g., block 1110) in dependence on the determining, and producing second prompting data (e.g., block 1113) in dependence on the ascertaining.

Embodiments herein recognize that while various prompting data can prompt for action by one or more worker (including prompting for collaborative action amongst multiple users), the actual action taken by the one or more worker can in some instances be different from the prompted for action, e.g, wherein workers exercise judgment to perform action other than specifically prompted for action.

According to a feature and advantage herein, manager system 110 can harness and leverage such differentiated work action (different than a prompted for action) performed by workers and can employ datasets specifying such differentiated actions for use in training of one or more iteratively trained predictive model, which iteratively trained predictive model can be queried for return of subsequent prompting data. Manager system 110, as set forth herein, can be iteratively recording data specifying actions of one or more worker including collaborative actions of groups of users, and iteratively, during the deployment period of manager system 110 can be using such data for training of one or more predictive model. As set forth in reference to the flowchart of FIGS. 3A-3B, manager system 110 can iteratively be storing IoT data referencing actions of one or more user at store block 1102 and can be using such action representing data for training one or more predictive model at training block 1104, which one or more predictive model can be queried for return of subsequently sent prompting data in a next iteration of prompting data sending e.g. at block 1113, 1114 and/or 1111.

The intelligence of manager system 110 accordingly grows over time to define an intelligent workflow. Embodiments herein recognize that even though in situations where resulting prompted for action resulting from prompting data being presented can differ from a prompted for action, the resulting action can be positively influenced by the presented prompting data. In other words, the resulting action can represent refinement, a perfection, and an improvement of a prompted for action. In one use case example, a prompted for action prompted for at send block 1111 can be the prompted for action that worker C and worker E, e.g., collaborate to “lift” a robot. However, exercising judgment, knowledge and understanding based on experience, the workers C and E can conclude that “pushing” the robot can produce an improved result and therefore can perform “pushing” rather than “lifting” of the robot.

In the described scenario, workers C and E benefit from the presented prompting data which references the proper physical asset to be acted on (the robot), but perform a differentiated alternative action other than the prompted for action. In the described manager system 110 grows in intelligence by its ability to detect the altered action (receiving, processing and storing IoT data as described in reference to blocks 2601, 1101, 1103, 1102 including detecting movement using worker movement predictive model 4506), determine the impact of the altered action is described in reference to worker action impact predictive model 4504 and Eq. 2, and can train worker action impact predictive model 4504 with a next iteration of training data specifying the impact of performing the differentiated alternative action. Based on the described updated training of worker action impact predictive model 4504, manager system 110 when generating subsequent prompting data (subsequent iteration of block 1110) can generate prompting data in dependence on the described next iteration of training of worker action impact predictive model 4504 (i.e., subsequent query of worker action impact predictive model 4504 at a subsequent iteration of block 1110 can produce a prediction in dependence on the updated training).

In another example, prompted for action can specify actions involving a control setting of a worker on one or more physical asset which can be sensed using a reading IoT sensor devices 1605, and the alternative action can involve alternative controls. In such a scenario, manager system 110 can record data specifying the alternative action based on sent data of one or more reading IoT sensor device 1605 and can employ the alternative action specifying data for updating training of workflow guiding predictive model 4502. In such a scenario, manager system 110 can generate at a subsequent iteration of block 1110 subsequent prompting data in dependence on query of workflow guiding predictive model 4502, now trained by the updated training.

Accordingly, there is set forth herein according to one embodiment, storing into a data repository internet of things (IoT) sensor data of a plurality of IoT devices disposed within a workflow environment that includes one or more physical asset; performing a simulation to simulate operating performance of the one or more physical asset disposed within the workflow environment, wherein the performing the simulation to simulate operating performance of the one or more physical asset disposed within the workflow environment includes using historical IoT data of the IoT sensor data; detecting, in dependence on the performing the simulation, that an alert condition is present in the workflow environment; and prompting one or more worker within the workflow environment to take action in response to the detecting that the alert condition is present in the workflow environment, wherein the method includes subsequent to the prompting one or more worker within the workflow environment to take action, recording data (e.g., block 1102) specifying responsive action by the one or more worker performed by the one or more worker responsively to the prompting, applying the data specifying the responsive action as training data for training a machine learning predictive model (e.g., block 1104), querying the machine learning predictive model subsequent to the training (e.g., block 1110), and generating (e.g., block 1110) subsequent prompting data for prompting at least one worker within the workflow environment in dependence on the querying.

Intelligent workflow refers to the automation and optimization of business processes using advanced technologies such as artificial intelligence (AI), including machine learning (ML), and natural language processing (NLP). Intelligent workflow can involve integrating smart decision-making capabilities into the workflow to enhance efficiency, accuracy, and productivity. Intelligent workflows in an industrial shop floor environment can significantly improve productivity, reduce costs, and enhance the overall efficiency of vehicle assembly processes.

In an automotive or other goods manufacturing plant, intelligent workflow can be applied to implement predictive maintenance for assembly line equipment and machinery. By utilizing sensors and IoT devices, real-time data can be collected from various components and machines on the shop floor. AI algorithms can then analyze this data to detect patterns, identify potential faults or malfunctions, and predict when maintenance or repairs will be required. This allows the plant to proactively schedule maintenance activities, avoiding unplanned downtime and optimizing the overall efficiency of the assembly line.

Intelligent workflow can be employed for quality control and defect detection. In one example, ensuring high quality vehicles is crucial in the automotive industry. An intelligent workflow can be established to automate quality control processes and defect detection during the assembly process.

In one embodiment, computer vision systems, combined with AI algorithms, can analyze images and videos captured from cameras placed strategically along the assembly line. The algorithms can compare the visual data against predefined standards and specifications, identify any defects or anomalies in real-time, and alert the operators or stop the assembly process if necessary. The described arrangement enables early detection of quality issues, minimizes the production of faulty vehicles, and enhances overall product quality.

Embodiments herein recognize that human involvement and collaboration can benefit an intelligent workflow's ability to handle complex decision-making, address exceptions, interpret data, drive continuous improvement, foster collaboration among stakeholders, and ensure ethical considerations are taken into account. Humans bring unique skills, judgment, and creativity that complement the capabilities of AI technologies, leading to more effective and responsible workflow implementation.

The following are some scenarios where human worker involvement is required in the intelligent workflow. In respect to complex decision-making, intelligent workflows can handle routine and repetitive tasks efficiently, but complex decision-making can benefit from human judgment and expertise. Humans possess contextual knowledge, experience, and intuition that cannot be replicated by AI algorithms alone. Humans can provide critical insights, assess ambiguous situations, and make informed decisions that consider a broader range of factors. In respect to exception handling, intelligent workflows can encounter exceptions or scenarios that fall outside the predefined rules or patterns. Human involvement can benefit the handling of these exceptions, analyze unique situations, and make decisions that deviate from the automated processes. Embodiments herein recognize that humans can apply creativity, adaptability, and problem-solving skills to address novel or unforeseen challenges. In regard to interpretation of data and results, embodiments herein recognize that while AI algorithms excel at data analysis, humans play a vital role in interpreting the results. Embodiments herein recognize that humans can contextualize the findings, validate the outcomes, and identify potential biases or limitations in the automated processes. Embodiments herein recognize that human judgment can benefit the validating and interpreting of insights derived from the intelligent workflow, ensuring their accuracy and reliability. In regard to continuous improvement, embodiments herein recognize that human involvement can benefit the continuously improving of intelligent workflows. Embodiments herein recognize that humans can review the performance of the automated processes, identify areas of improvement, and suggest modifications or optimizations. Embodiments herein recognize that humans can provide feedback based on their practical experience and domain expertise, enabling iterative enhancements to the workflow and its underlying algorithms. In regard to collaboration and communication, embodiments herein recognize that intelligent workflows often involve multiple stakeholders and teams. Embodiments herein recognize that human collaboration facilitates effective communication, coordination, and cooperation among these stakeholders. Embodiments herein recognize that humans can interact, exchange information, and align their actions to achieve shared goals. Embodiments herein recognize that collaboration can ensure that different perspectives, ideas, and expertise are leveraged to optimize the workflow and achieve better outcomes. In regard to ethical and social considerations, embodiments herein recognize that intelligent workflows should adhere to ethical guidelines and align with societal values. Humans provide the moral compass and ethical judgment that can benefit the responsible use of AI technologies. Embodiments herein recognize that humans can assess the social impact of the workflow, consider potential biases or discriminatory outcomes, and make ethical decisions that align with human values and fairness.

In one embodiment, an intelligent workflow can be executing in any industrial floor, and, for various reason, the AI enabled system may not have the required level of confidence level to execute a decision and can responsively proactively create a virtual reality collaborative environment so that the execution effectiveness of intelligent workflow is maximum.

Embodiments herein recognize that intelligent workflows can minimize friction through automation and drive insights for immediate action.

Embodiments herein can consider predicted confidence level for executing intelligent workflow at different stages of any process in the industrial floor and accordingly be predicting where human worker involvement can reduce the poor confidence level of executing intelligent workflow. Embodiments herein can proactively initiate human worker collaboration on those identified steps of the business process, so that with human collaboration and automation systems, the intelligent workflow can effectively be executed.

Based on a determining that human collaboration can benefit an intelligent workflow, the system can proactively send a collaboration invite with appropriate timing and duration of collaboration, so that required types of human workers are available at the time of executing intelligent workflow.

While sending invites to the human workers, the system can also be identifying what types of information input will be required from the human worker, so that during VR collaboration, the human workers will be providing relevant input to the intelligent workflow.

Based on the determining that human collaboration can benefit an intelligent workflow, the system can proactively deploy appropriate infrastructure around stages of an intelligent workflow. The proactively deployed infrastructure can be creating streaming activity surrounding a stage of the business process, so that virtual reality collaboration can be started.

In one embodiment, the system can be predicting if there may be any expectation handling is to be performed, or the AI system does not have required knowledge, then the system can be dynamically initiating virtual reality collaboration, so that multiple human workers along with the AI system can make an appropriate decision.

If human collaboration is established against any stage of an industrial process, the AI enabled intelligent workflow can be receiving input from the human worker and can be creating a human and AI system collaborative environment, so that human input can be considered while executing the intelligent workflow, and the human input (including behavior and actions) can also be considered in a learning process.

Where workers are involved in the VR reality collaborative environment, and participate with AI based intelligent workflow execution, then the workers can also perform activity in a teleoperation mode, and accordingly, remote robotic system can be performing the activity physically, and intelligent workflow can be executed with human activity.

In one embodiment, the system can determine that intelligent workflow execution confidence level for one or more stage does not satisfy a threshold, and accordingly, the system can predict that human involvement can benefit the intelligent workflow, and accordingly, the system can send a proactive VR meeting invite, so that the intelligent workflow can obtain input from the human worker and resume execution.

Embodiments herein can include, at stage 1, a method to build a knowledge corpus to execute intelligent workflow in any industrial floor. Stage 1 can include (a) based on historically collected data from different types of activities in any industrial floor, manager system 110 can be creating a knowledge corpus to execute different types of intelligent workflow, and during the building of the knowledge corpus, manager system 110 can be collecting, organizing, and structuring relevant information. Stage 1 can also include (b) manager system 110 determining the specific types of intelligent workflows that are needed for various processes on the industrial floor. This could include tasks such as predictive maintenance, quality control, resource optimization, or production scheduling. Stage 1 can also include (c) manager system 110 categorizing the knowledge that is relevant to each workflow type. This could include domain-specific information, technical specifications, operating procedures, troubleshooting guides, regulations, best practices, and any other knowledge elements that impact the execution of the workflows, including defining categories or topics to organize the knowledge effectively. Stage 1 can also include (d) manager system 110 considering existing documentation, manuals, procedures, guidelines, and any other relevant resources that provide information about the industrial processes and workflows, and can also be considering the IoT feeds from the actual activities, this may include materials from internal sources, equipment manufacturers, industry standards, or research publications. Stage 1 can also include (e) during the building of the knowledge corpus, manager system 110 can also receive feeds from domain experts, process engineers, operators, and other stakeholders involved in the industrial processes. Stage 1 can also include (f) manager system 110 considering relevant data sources that can contribute to the knowledge corpus. This could include historical process data, sensor data, maintenance logs, quality records, production reports, or any other data that provides insights into the workflows and their performance as well as ensuring that the data is properly anonymized and adheres to privacy and security regulations. Stage 1 can also include (g) using NLP models to extract information, classify documents, perform text summarization, and identify relevant concepts and entities within documents. NLP models such as BERT (Bidirectional Encoder Representations from Transformers), GPT (Generative Pre-trained Transformer), or word2vec can help analyze textual information in the knowledge corpus. Stage 1 can also include (h) constructing graphs for representing the information in a structured format, capturing relationships between entities. Stage 1 can also include (i) using topic modelling techniques, such as Latent Dirichlet Allocation (LDA) or Non-negative Matrix Factorization (NMF), to uncover latent topics and themes within the knowledge corpus. These models automatically identify clusters of related documents and assign them to different topics. Topic modelling helps organize and categorize the information within the corpus, making it easier to navigate and retrieve relevant content. Stage 1 can also include (k) (if the intelligent workflows are having visual data or require analyzing images) employing deep learning models such as Convolutional Neural Networks (CNNs) can be utilized. CNNs can process images, extract features, and perform tasks like object detection, image classification, or anomaly detection. These models can be trained to analyze images from industrial processes and provide insights or identify potential issues. Stage 1 can also include (1) the intelligent workflow learning from collaborations with humans and integrate the solutions, decisions, and additional knowledge into the learning corpus for future reference if the same issue were to reemerge.

Embodiments herein can also include, at stage 2, a method to perform digital twin simulation in any industrial floor to identify where intelligent workflow is to be executed. Stage 2 can include (a) a data integration framework to collect, process, and integrate the data from different sources. This may involve leveraging IoT platforms, data pipelines, APIs, or other connectivity solutions to aggregate and pre-process the data for use in the digital twin simulation. Stage 2 can also include (b) the provisioning of one or more digital twin asset model that represents the industrial floor and its components. The model should incorporate the physical attributes, behaviors, and functionalities of the equipment and systems involved. Stage 2 can also include (c) use AI algorithms that are appropriate for the specific tasks and workflows to be executed within the digital twin simulation. This may include image processing algorithms for analyzing visual data, machine learning models for predictive maintenance, anomaly detection, optimization, or decision-making algorithms for situational data analysis. Stage 2 can also include (d) use of predefined simulation scenarios that reflect real-world conditions and operational scenarios of the industrial floor. Manager system 110 can examine different operating conditions, environmental factors, and potential disturbances or failures that may occur and configure the simulation parameters and inputs accordingly. Stage 2 can also include (e) the running of the digital twin simulation using the configured scenarios and input data as well as monitoring the simulation outputs, including the behavior of the equipment, performance metrics, or any anomalies detected by the AI algorithms and analyzing the results to gain insights into the performance, efficiency, and potential areas for improvement in the industrial floor. Stage 2 can also include (f) manager system 110 analyzing the simulation results to identify areas where the intelligent workflow should be executed. Manager system 110 can be looking for patterns, trends, or anomalies in the data that indicate opportunities for optimization, process improvement, or the application of intelligent workflows as well as interpreting the results to gain insights into the potential benefits, risks, or challenges associated with implementing the intelligent workflow.

Embodiments herein can also include, at stage 3, a method to evaluate the digital twin simulation results and compare Intelligent workflow execution logic to identify where intelligent workflow will not be able to execute properly. Stage 3 can include (a) manager system 110 employing specific types of predefined prerequisites and requirements for executing the intelligent workflow. This includes understanding the expected inputs, data sources, dependencies, performance metrics, and desired outcomes of the workflow, surrounding context, etc. Stage 3 can also include (b) a set of defined KPIs, that will be used to evaluate the success of the intelligent workflow execution. These metrics should align with the goals and objectives of the workflow and provide measurable indicators of its effectiveness. Stage 3 can include (c) analyzing the results generated from the digital twin simulation. This may include data on equipment behavior, system performance, process efficiency, or any other relevant outputs captured during the simulation as well as ensuring that the simulation results are properly recorded and organized for analysis. Stage 3 can include (d) manager system 110 comparing the simulation results with the prerequisites for the intelligent workflow execution as well as assessing whether the simulation outputs meet the expected criteria and performance metrics and identifying any gaps, discrepancies, or areas where the simulation results deviate from the desired outcomes of the workflow. Stage 3 can include (e) manager system 110 analyzing the available data and assessing its sufficiency for executing the intelligent workflow, identifying the data inputs required by the workflow and compare them with the data captured during the simulation, determining whether the available data is complete, accurate, and representative of real-world conditions, and identifying any data insufficiencies, missing variables, or limitations that may affect the execution of the workflow. Stage 3 can include (f) based on the analysis of data insufficiencies that hinder the execution of the intelligent workflow, manager system 110 can determine which data variables or attributes are missing, incomplete, or unreliable and can consider the impact of these data insufficiencies on the workflow's ability to deliver the desired outcomes or meet the predefined performance metrics. Stage 3 can include (g) identifying the steps of the intelligent workflow where data is insufficient to execute the intelligent workflow, and what types of data and information are not available.

Embodiments herein can also include, at stage 4, a method to identify the collaboration requirement where human workers are to be involved. Stage 4 can include (a) based on identified data insufficiency, manager system 110 considering worker skill sets database, and identifying what types of workers will be required to perform the activity. Stage 4 can also include (b) manager system 110 identifying data insufficiency of an intelligent workflow that can be compensated for by human workers. Stage 4 can also include (c) identifying the physical activity location, where the execution of intelligent workflow will have lower than threshold limit of confidence level. Stage 4 can also include (d) identifying the execution sequence of intelligent workflow and will predict the timeline when the intelligent workflow will be requiring human worker involvement. Stage 4 can also include (e) based on historical learning about the execution of different workflow step, predicting how long human worker involvement will be required. Stage 4 can also include manager system 110 (f) once the identified types of workers skills, their involvement time, and duration of human worker are identified, creating a meeting request and sending the same to the appropriate human workers.

Embodiments herein can also include, at stage 5, a method to capture human worker's input while executing the intelligent workflow. Stage 5 can include (a) sending virtual reality meeting invite to the human workers who would be participating to provide additional manual input to the intelligent workflow. Stage 5 can also include (b) based on the identified steps of the business process where the collaboration request is sent, then intelligent workflow will be waiting for human worker input to resume the intelligent workflow at the step. Stage 5 can also include (c) creating a virtual reality environment, around the business process steps where human involvement is required, depth cameras can be installed to capture volumetric video and streaming the same to VR environment. Stage 5 can also include (d) during VR collaboration, the human workers can perform teleoperation action, verbal or gesture-based command to the intelligent workflow system, and accordingly the intelligent workflow will be executed. Stage 5 can also include (e) considering the human worker's input and will be using the same to mature the intelligent workflow. Stage 5 can also include (f) learning from the human worker to determine if the human actions/behavior can be replicated for future execution of like workflow.

Various available tools, libraries, and/or services can be utilized for implementation of trained predictive models herein trained by machine learning, such as predictive model 4502, predictive model 4504, predictive model 4506, and/or predictive model 4508. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

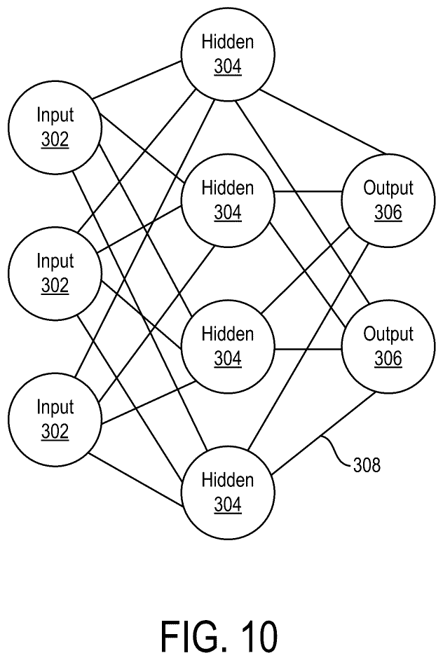

FIG. 10 is an illustration of an example ANN architecture for trained predictive models herein trained by machine learning, such as predictive model 4502, predictive model 4504, predictive model 4506, and/or predictive model 450.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with predictive model 4502, predictive model 4504, predictive model 4506, and/or predictive model 450.

Referring now to FIG. 10, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive models 4502, 4504, 4506, and 4508 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer networks. Embodiments herein can employ predictive models for guiding workers in the performance of industrial workflows and which can be dependent on worker action. Embodiments herein can employ trained predictive models trained with use of training data for performance of simulations in which a trained predictive model can be used to generate predictions as to subsequent performance of a workflow environment, including one or more physical asset. Embodiments herein can include use of historical IoT sensor data for use in training one or more predictive model. Embodiments herein can include monitoring predictive performance of a predictive model and generating prompting data for prompting one or more worker in dependence on the monitoring. Embodiments herein can include prompting workers to collaborate in regard to remediation of an alert condition responsively to determination that a predictive model simulating performance of a workflow environment is producing predictions that do not satisfy a threshold level of accuracy. Embodiments herein can include recognizing and recording actions of workers within a workflow environment and applying data specifying actions of users as training data for training of worker action impact predictive model that predicts an impact of one or more worker performing the specified action. Embodiments herein can generate prompting data for prompting one or more worker to take a specified action in dependence on a predicted result of the one or more worker taking a specified action. Embodiments herein can include provisions for lightweight processing of image data, including image data representing workers in a workflow environment, the image data representing workflow products, and containers for packaging the same. Various decision data structures can be used to drive artificial intelligence (AI) decision making, such as decision data structure. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

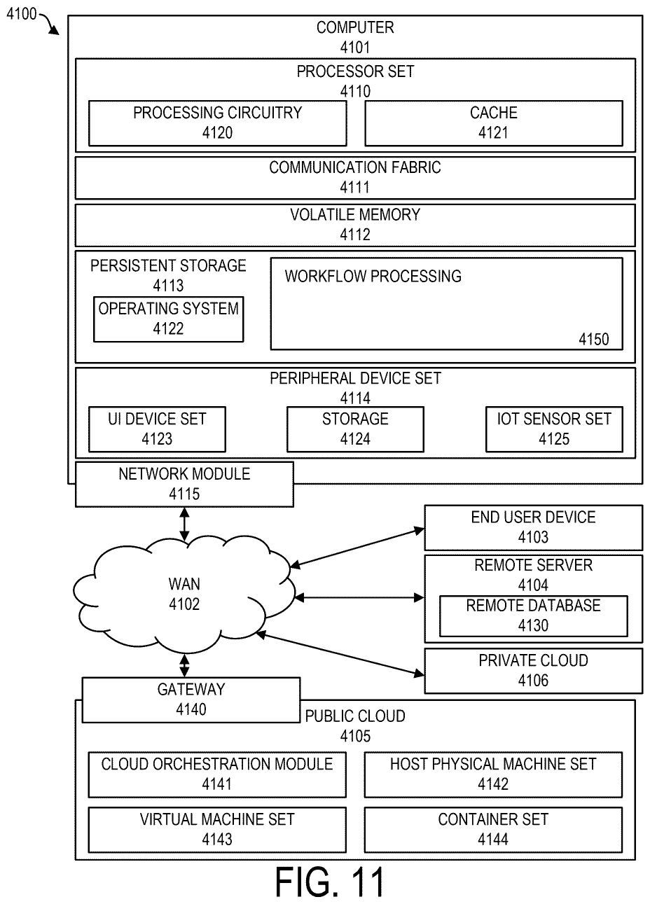

In reference to FIG. 11 there is set forth a description of a computing environment 4100 that can include one or more computer 4101. In one example, a computing node as set forth herein can be provided in accordance with computer 4101 as set forth in FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 11. In one aspect, a computing environment 4100 contains an example of an environment for the execution of at least some of the computer code involved in performing the inventive methods, such as code 4150 for performing workflow processing as described with reference to FIGS. 1-10. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implement method comprising:
storing into a data repository internet of things (IoT) sensor data of a plurality of IoT devices disposed within a workflow environment that includes one or more physical asset;
performing a simulation to simulate operating performance of the one or more physical asset disposed within the workflow environment, wherein the performing the simulation to simulate operating performance of the one or more physical asset disposed within the workflow environment includes using historical IoT data of the IoT sensor data;
detecting, in dependence on the performing the simulation, that an alert condition is present in the workflow environment; and
prompting one or more worker within the workflow environment to take action in response to the detecting that the alert condition is present in the workflow environment.

2. The computer implemented method of claim 1, wherein the method includes evaluating accuracy of one or more key performance indicator (KPI) prediction resulting from the performing the simulation, wherein the detecting that the alert condition is present is in dependence on the evaluating.

3. The computer implemented method of claim 1, wherein the method includes evaluating accuracy of one or more key performance indicator (KPI) prediction resulting from the performing the simulation, wherein the detecting that the alert condition is present is in dependence on evaluating, wherein the prompting the one or more worker to take action in response to the detecting that the alert condition is present in the workflow environment includes prompting the one or more worker to take action via UE devices of the one or more worker.

4. The computer implemented method of claim 1, wherein the detecting, in dependence on the performing the simulation that an alert condition is present in the workflow environment includes determining that the alert condition is characterized by one or more predicted KPI parameter value predicted by the simulation failing to satisfy a performance threshold, and ascertaining that the alert condition is characterized by a predictive accuracy of the simulation failing to satisfy an accuracy threshold, wherein the prompting one or more worker within the workflow environment to take action in response to the detecting that the alert condition is present in the workflow environment includes generating first prompting data in dependence on the determining, and producing second prompting data in dependence on the ascertaining.

5. The computer implemented method of claim 1, wherein the method includes subsequent to the prompting one or more worker within the workflow environment to take action, recording data specifying responsive action performed by the one or more worker responsively to the prompting, applying the data specifying the responsive action as training data for training a machine learning predictive model, querying the machine learning predictive model subsequent to the training, and generating subsequent prompting data for prompting at least one worker within the workflow environment in dependence on the querying.

6. The computer implemented method of claim 1, wherein the method includes evaluating accuracy of one or more key performance indicator (KPI) prediction resulting from the performing the simulation, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually.

7. The computer implemented method of claim 1, wherein the performing the simulation includes querying a predictive machine learning model that has been trained with training data that includes the historical IoT data of the IoT sensor data, wherein the method includes evaluating accuracy of one or more key performance indicator (KPI) prediction resulting from the performing the simulation, wherein the evaluating the accuracy of the one or more key performance indicator (KPI) prediction resulting from the performing the simulation includes comparing real time KPI data to predicted KPI data produced on querying the predictive machine learning model with use of a test query, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually.

8. The computer implemented method of claim 1, wherein the method includes recording data specifying an historical action of at least one worker within the workflow environment, storing historical impact data indicating an impact of the historical action on at least one key performance indicator (KPI) of the workflow environment, and predicting with use of the historical impact data a result of performing a candidate action, wherein the prompting one or more worker within the workflow environment to take action in response to the detecting that the alert condition is present in the workflow environment includes prompting the one or more worker within the workflow environment to take action in dependence on the predicting.

9. The computer implemented method of claim 1, wherein the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions.

10. The computer implemented method of claim 1, wherein the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions, wherein the predicting includes querying a trained machine learning model that has been trained with training data provided by the impact data of the historical impact data.

11. The computer implemented method of claim 1, wherein the performing the simulation includes querying a predictive neural network machine learning model that has been trained with training data that includes the historical IoT data of the IoT sensor data, wherein the method includes evaluating accuracy of one or more key performance indicator (KPI) prediction resulting from the performing the simulation, wherein the evaluating the accuracy of the one or more key performance indicator (KPI) prediction resulting from the performing the simulation includes comparing real time KPI data to predicted KPI data produced on querying the predictive neural network machine learning model with use of a test query, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually, wherein the method includes recording data specifying historical action of multiple workers within the workflow environment, storing historical impact data indicating an impact of the historical action on at least one key performance indicator (KPI) of the workflow environment, and predicting with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions, wherein the predicting includes querying a trained machine learning model that has been trained with training data provided by the impact data of the historical impact data.

12. The computer implemented method of claim 1, wherein the method includes recording data specifying historical actions of one or more group of workers within the workflow environment, wherein the recording includes obtaining an image presentation of two or more workers, processing an image representation to produce a skeletal multi-joint representation of the two or more workers, and querying a trained neural network with use of the skeletal multi-joint representation of the two or more workers for return of an action classifier for the two or more workers, storing, for respective ones of the historical actions of the one or more group of workers impact data indicating an impact of the respective ones of the historical actions on at least one key performance indicator (KPI) of the workflow environment, and predicting, with use of impact data of the historical impact data a result of performing a plurality of candidate actions, and producing a ranked order of the respective ones of the candidate actions in dependence on the predicting, wherein the prompting one or more worker within the workflow environment to take action in response to the detecting that the alert condition is present in the workflow environment includes prompting the one or more worker within the workflow environment to take action in dependence on the ranked order of the respective ones of the candidate actions.

13. A system comprising:
a memory;
at least one processor in communication with the memory; and
program instructions executable by one or more processor via the memory to perform a method comprising:
storing into a data repository internet of things (IoT) sensor data of a plurality of IoT devices disposed within a workflow environment that includes one or more physical asset;
performing a simulation to simulate operating performance of the one or more physical asset disposed within the workflow environment, wherein the performing the simulation to simulate operating performance of the one or more physical asset disposed within the workflow environment includes using historical IoT data of the IoT sensor data;
detecting, in dependence on the performing the simulation, that an alert condition is present in the workflow environment; and
prompting one or more worker within the workflow environment to take action in response to the detecting that the alert condition is present in the workflow environment.

14. The system of claim 13, wherein the method includes evaluating accuracy of one or more key performance indicator (KPI) prediction resulting from the performing the simulation, wherein the detecting that the alert condition is present is in dependence on the evaluating.

15. The system of claim 13, wherein the method includes evaluating accuracy of one or more key performance indicator (KPI) prediction resulting from the performing the simulation, wherein the detecting that the alert condition is present is in dependence on evaluating, wherein the prompting the one or more worker to take action in response to the detecting that the alert condition is present in the workflow environment includes prompting the one or more worker to take action via UE devices of the one or more worker.

16. The computer implemented method of claim 13, wherein the detecting, in dependence on the performing the simulation that an alert condition is present in the workflow environment includes determining that the alert condition is characterized by one or more predicted KPI parameter value predicted by the simulation failing to satisfy a performance threshold, and ascertaining that the alert condition is characterized by a predictive accuracy of the simulation failing to satisfy an accuracy threshold, wherein the prompting one or more worker within the workflow environment to take action in response to the detecting that the alert condition is present in the workflow environment includes generating first prompting data in dependence on the determining, and producing second prompting data in dependence on the ascertaining.

17. The system of claim 13, wherein the method includes subsequent to the prompting one or more worker within the workflow environment to take action, recording data specifying responsive action performed by the one or more worker responsively to the prompting, applying the data specifying the responsive action as training data for training a machine learning predictive model, querying the machine learning predictive model subsequent to the training, and generating subsequent prompting data for prompting at least one worker within the workflow environment in dependence on the querying.

18. The system of claim 13, wherein the method includes evaluating accuracy of one or more key performance indicator (KPI) prediction resulting from the performing the simulation, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually.

19. The system of claim 13, wherein the performing the simulation includes querying a predictive machine learning model that has been trained with training data that includes the historical IoT data of the IoT sensor data, wherein the method includes evaluating accuracy of one or more key performance indicator (KPI) prediction resulting from the performing the simulation, wherein the evaluating the accuracy of the one or more key performance indicator (KPI) prediction resulting from the performing the simulation includes comparing real time KPI data to predicted KPI data produced on querying the predictive machine learning model with use of a test query, wherein the detecting that the alert condition is present is in dependence on the evaluating, wherein the prompting the one or more worker to take action in response to the detecting that the alert condition is present in the workflow environment includes prompting a plurality of workers in the workflow environment to participate in a virtual reality session in which the one or more physical asset within the workflow environment is represented virtually.

20. A computer program product comprising:
a computer readable storage medium readable by one or more processing circuit and storing instructions for execution by one or more processor for performing a method comprising:
storing into a data repository internet of things (IoT) sensor data of a plurality of IoT devices disposed within a workflow environment that includes one or more physical asset;
performing a simulation to simulate operating performance of the one or more physical asset disposed within the workflow environment, wherein the performing the simulation to simulate operating performance of the one or more physical asset disposed within the workflow environment includes using historical IoT data of the IoT sensor data;
detecting, in dependence on the performing the simulation, that an alert condition is present in the workflow environment; and
prompting one or more worker within the workflow environment to take action in response to the detecting that the alert condition is present in the workflow environment.
